(19) United States
(12) Patent Application Publication
(10) Pub. No.: US 2003/0046050 A1
(43) Pub. Date: Mar. 6, 2003

(54) Method of providing integration of atomistic and substructural multi-body dynamics

(76) Inventors: Carlos E. Padilla, Lexington, MA (US); Valeri I. Karlov, Boston, MA (US)

Correspondence Address: McDermott, Will & Emery, 28 State Street, Boston, MA, 02109, US

(21) Appl. No.: 10/032,745

(22) Filed: Oct. 22, 2001

Related U.S. Application Data
(60) Provisional application No. 60/241,878, filed on Oct. 20, 2000.

(51) Int. Cl. G06G 7/48; G06G 7/58

(52) U.S. Cl. 703/12

(57) ABSTRACT

A method of simulating multibody dynamics of a molecular system so as to produce output data representative of a time evolution of the molecular system includes providing a set of equations for characterizing multibody dynamics of the molecular system. The set of equations is constrained by a constraining equation. The method further includes providing an integrator for integrating the set of equations. The integrator is tailored for the set of equations so as to satisfy the constraining equation. The method further includes applying the integrator to the set of equations over a time step, so as to produce output data representative of the time evolution of the molecular system relative to the time step.

### CROSS-REFERENCE TO RELATED APPLICATIONS

This application claims the benefit of U.S. Provisional Application No. 60/241,878 entitled “METHOD OF PROVIDING INTEGRATION OF ATOMISTIC AND SUBSTRUCTURAL MULTI-BODY DYNAMICS” filed on Oct. 20, 2001, the disclosure of which is entirely incorporated herein by reference.

### STATEMENT REGARDING FEDERALLY SPONSORED RESEARCH

This invention was made with government support under Air Force SBIR Contract No. F49620-96-C-0035. The government has certain rights in the invention.

The U.S. Government has a paid-up license in this invention and the right in limited circumstances to require the patent owner to license others on reasonable terms as provided for by the terms of Air Force SBIR Contract No. F49620-96-C-0035.

### REFERENCE TO MICROFICHE APPENDIX

Not Applicable

### BACKGROUND OF THE INVENTION

The present invention relates to molecular modeling, and more particularly, to systems for and methods of providing molecular dynamics simulations.

Over the past decade, numerous classical all-atom molecular dynamics (MD) simulation methods have been developed with the promise of revolutionizing chemical design-intensive industries by enabling computer-based research, design and analysis of large molecular systems (e.g., proteins, polymers) prior to laboratory synthesis and testing. Effectively, these MD methods model the time-evolving classical dynamics trajectory of each individual atom in a molecule, from which important physical properties can be derived.

Indeed, the pharmaceutical industry, particularly, embraced the promise of MD early-on and has spent much of the past decade attempting to use it to support drug design research. Completion of sequencing the human Genome by both government and private organizations have significantly boosted the role of molecular dynamics in biotechnology. Now when the sequences of hundreds of thousands of proteins are available, and 3D protein structures for them are evaluated via homology methods, there is a need in highly accurate molecular modeling via MD simulations. Some companies (e.g., Structural Bioinformatics Inc.) is now making MD simulations a part of high-throughput process for creating 4D structural databases for Genome sequences. Note that the “fourth” dimension here entails “time”, i.e., the 4D database will also provide dynamic information about 3D protein structures. This dynamic protein structural information may be used to generate virtual constructs of protein pharmacophores (referred to as DynaPharm™ templates) that play an important role in structure-based drug design.

Beyond the biotechnology applications, the materials industry has explored the use of MD (but to a somewhat lesser extent) in designing polymers, composites, and other new materials.

Unfortunately, the utility of classical all-atom MD has not met expectations, primarily because it is restricted to severely short timesteps (0.5-1 femtoseconds) required to handle the high frequency content in the dynamics equations. In application to large biological and polymeric molecules, where the event durations of interest are in the nano-, micro-, and in some cases milli-second domains, such short timesteps result in a computationally intensive process. Given that drug and material design researchers typically examine tens-to-hundreds of thousands of candidate leads and derivatives in the search for a new product, the use of all-atom MD becomes prohibitive, and hence its utility has been severely limited.

A highly promising approach that has emerged, known as MBO(N)D (Multibody Order (N) Dynamics), aggregates, or substructures, groups of atoms in a molecule into flexible (or rigid) bodies in order to simulate essential low frequency dynamics. Elimination of the unimportant high frequency content through this multibody approach allows the use of much longer timesteps, in what is referred to herein as substructured molecular dynamics (SMD). The integrator utilized for multibody dynamics is critical to successfully attaining long timesteps for SMD, particularly with respect to stability, and the number of forcefield evaluations required for each step.

It is non-trivial to analyze the effectiveness of candidate integration algorithms for large-scale MD problems. The classical MD of macromolecules (e.g., proteins, nucleic acids, and polymers) is governed by Newton's equations of dynamics:

$$M \frac{{ⅆ}^{2}}{ⅆ {t}^{2}} q = - {∇}_{q} V ( q ) \qquad ( 1 )$$

where q is the vector of the Cartesian positions of each atom, M is a diagonal mass matrix containing the mass of each atom, and V is the potential energy function. Equation (1) is highly nonlinear and, for typical macromolecules, has a phase space with large dimensionality. In effect, the trajectories prescribed by Eq. (1) exhibit chaotic behavior in the form of high sensitivity to initial conditions. This, coupled to the long time scales necessary for MD, make it impossible to use standard measures such as stability and accuracy (as normally defined in the literature of numerical integrators, i.e., with respect to a given trajectory) to measure the effectiveness of a numerical discretization solution of Eq. (1). This difficulty has led researchers to seek alternative ways to judge the quality of the numerical solutions of Eq. (1). One such alternative consists of showing that the resulting solution trajectory is “close” to the true trajectory of a “nearby system of differential equations.” This nearby system should possess similar dynamic properties to the original one.

This approach has contributed to the increasing interest in symplectic integrators for use in classical MD. The system of Eq. (1) is a Hamiltonian system. Hamiltonian systems possess symplectic invariants. In two dimensions, this means that the flow of the Hamiltonian system preserves areas in phase space. In higher dimensions, this is a much stronger geometrical property of the flow of the system that has as one of its consequences the preservation of volume in the higher dimensional phase space. The relevant result is that it has been shown that a symplectic numerical discretization of a Hamiltonian system will result in trajectories that are the true trajectories of a “nearby” Hamiltonian system. Thus, a numerical integration algorithm that preserves the symplectic property of Eq. (1) is seen as desirable. As it turns out, the consequences of symplecticness for MD are not clear. As a practical matter, however, some very effective integration schemes, such as leapfrog Verlet, have been shown to be symplectic. Another strong property of the flow (or set of solutions) of a Hamiltonian system is that it is time reversible. Thus numerical integration schemes that exhibit time-reversibility (and have already passed muster with respect to classical stability and accuracy in simpler systems) are also desirable. This property may be of importance for long-term dynamics. Leapfrog Verlet is also a time reversible discretization scheme.

Thus, using the above measures as indicators of the potential effectiveness of a candidate integration algorithm, researchers have searched for ways to alleviate the restriction on the integration timestep imposed by the high frequency dynamics of Eq. (1). Three categories of numerical integration schemes relevant to this analysis are:

1) explicit methods that use small timesteps to accurately resolve the high frequencies;

2) implicit methods that inaccurately resolve the high frequencies in order to achieve larger timesteps; and,

3) methods that incorporate constraints to eliminate the high frequencies (e.g., prior art systems SHAKE and RATTLE, see Ferrario, M., and Ryckaert, J. P., Molec. Phys., 54 (3) 587, (1985); Ryckaert J. P., Ciccoti G., and Berendsen H. J. C., Numerical Integration of the Cartesian Equations of Motion of a System with Constraints: Molecular Dynamics of N-Alkanes, J. of Comput. Physics, 23, 327-341 (1977); and, Allen, M. P., and Tildesley, D. J., Computer Simulation of Liquids, Oxford Science Publications, 1987.).

Among the integrators in category 1 are the already mentioned leapfrog Verlet, together with its close relatives Verlet, Velocity Verlet, and position Verlet. In addition, multistep Gear methods and some higher order symmetric multistep methods have been tried. These all suffer from the small timestep problem. Among the multistep methods, the Gear methods are not symplectic or time-reversible, and exhibit poor long term energy conservation. The higher order symmetric methods have not been shown to be symplectic but are time-reversible and exhibit good accuracy with minimal forcefield evaluations. It is not believed that significant improvements in integrator efficiency will result, though, for the accuracies needed for MD.

The integrators in category 2 suffer from two related drawbacks. The first and more obvious drawback is the fact that an implicit integrator, such as the implicit midpoint method, requires iterative solution. Due to the high cost of evaluating the potential in Eq. (1) (cost is O(n²) where n is the number of atoms), even when non-bond pairlist cutoffs are used, an iterative solution carries with it a large computational cost. By contrast, the Verlet family of integrators require only one forcefield evaluation per step. To overcome this drawback of the implicit integrators, larger timesteps must be taken, which is in line with the original intent in going to category 2 integrators in the first place. However, the second, more subtle, drawback of these implicit integrators appears when larger timesteps are taken. Larger timesteps mean that higher frequency dynamics of the MD system of Eq. (1) are not accurately resolved. While this may be acceptable for linear systems if we are only interested in the low frequency behavior, coupling of principal or “normal” modes of the motion in highly nonlinear systems such as that of Eq. (1) will result in very inaccurate dynamics, even for the low frequencies, if the high frequencies are poorly resolved.

Category 3 integrators are the most promising in terms of reducing the high frequency content of the classical MD equations of motion, while reproducing accurate dynamics, if it can be done at a reasonable cost (only one forcefield evaluation per step). Verlet integrators with SHAKE and RATTLE have been shown to be second-order, time-reversible, symplectic discretizations of the system of Eq. (1) modified to incorporate bond length (and angle) constraints. They require only one forcefield evaluation per step, and the iterative solution of the position constraint equations can be made to converge in very few cycles under typical conditions. Unfortunately, the use of SHAKE (or RATTLE) to enforce bond length constraints results in a timestep increase of only a factor of four at best (2 femtosecond (fs) timesteps instead of 0.5-1fs normally required for Eq. (1) in the case of proteins). This increase in timestep is a marked improvement but not nearly enough to allow classical MD to approach the timescales of interest (micro to milliseconds).

Scientists have explored the application of multibody dynamics (MBD) modeling techniques to the problem of molecular dynamics of biological and materials macromolecules. The ultimate objective of these efforts is to achieve a reduced-variable MD modeling capability that will reduce the time required for MD by orders of magnitude and thus enable long-time simulations into the timescales of interest to the scientific and commercial drug design and materials communities. This is to be achieved by a combination of techniques that include fast forcefield evaluation through multipole approximations, fast MBD algorithms enabled by substructuring, and reduction of high frequency content via the use of substructuring and MBD that will allow the use of very large timesteps.

MBD techniques as applied to MD work on the principle of reducing high frequency dynamics content through the aggregation of groups of atoms that exhibit correlated motions into rigid or flexible bodies (the process of substructuring). If rigid bodies are used, this is akin to enforcing “hard” constraints between all the atoms that comprise that body. If the body is flexible, “soft” constraints are enforced. MBD flexible “constraints” are more abstract and are closely tied to the concept of the flexible body. The bodies are connected together in a topological chain (which in all generality also includes closed loops) that usually follows the natural topology of the macromolecule (though this is not a limitation). Hinges between bodies are characterized by relative degrees of freedom (DOF) between the bodies, and these DOF can be free, fixed (constrained), or their motion can be prescribed (rheonomic constraints). From the aforegoing discussion, it is evident that these MBD techniques properly fall into the category 3.

As is the case for classical MD, the quality of the numerical solutions of MBD equations depends on the properties of the numerical integrators. In fact, it has been pointed out extensively in the MBD literature that formulation and numerical integration are intimately related for MBD systems. It should come as no surprise, then, that integrators that work very well for classical MD systems are not effective for MBD systems. What is perhaps less expected is that classical integrators that have worked well for mechanical and aerospace MBD systems do not perform well when applied to MBD systems for substructured MD (SMD).

The remainder of this section addresses the reason for the inadequacy of classical MD (Verlet family) integrators for SMD, then describes in some detail the issues associated with MBD integration schemes. As described above, some category 1 explicit integrators for classical MD (Verlet integrators in particular) have desirable symplectic and time-reversibility properties. These properties translate into excellent long-term stability of energy as well as linear and angular momenta. In addition, they require only one function evaluation per step. What has not been mentioned yet is the fact that these Verlet discretizations take advantage of the particular form of the Hamiltonian for the system of Eq. (1) by “splitting” it. This process is similar to the Trotter decomposition of the Liouville operator formalism. Due to the simple form of the Hamiltonian, the equations for the derivatives of the momenta do not depend on the momenta themselves (the right hand side or “forcing” terms depend only on the generalized coordinates). This simple form contributes to the simplicity and effectiveness of the Verlet algorithm. Unfortunately, MBD equations do not possess the same simple structure. Instead, terms quadratic in the velocity variables appear due to gyroscopic impressed forces, which precludes a straightforward implementation of Verlet integrators to SMD equations.

The field of multibody dynamics has its roots in mechanical and aerospace applications and has been extensively developed over the last twenty years; with the bulk of the developments for spatial chains of flexible bodies and recursive formulations for flexible robotic manipulators coming in the last ten years. Driving the technology were aerospace applications concerned with large flexible spacecraft with multiple “bodies,” as well as light, flexible, robotic manipulators for space applications. Multibody systems are characterized by b bodies (with n=6*b DOF), which can be rigid or flexible (in which case n=6*b+f, where f is the total number of flexible degrees of freedom), connected together with a certain topology “enforced” by m constraints between pairs of bodies. The generic equations of motion for such a system, which can be derived by a variety of formalisms, is given by:

$$( \begin{matrix}M ( q ) & {[ {g}^{′} ( q ) ]}^{T} \\ {g}^{′} ( q ) & 0\end{matrix} ) ( \frac{\ddot{q}}{λ} ) = ( \begin{matrix}G ( t , q , \dot{q} ) \\ Y ( q , \dot{q} )\end{matrix} ) \qquad ( 2 )$$

together with

g(q)=0 (3)

gᵥ(q,\dot{q})=g′(q)\dot{q}=0(=\dot{g}) (4)

where q is the n×1 position vector, M(q) is the mass matrix, G(t,q,dq/dt) is the vector of generalized applied and impressed forces, λ is the L×1 vector of Lagrange multipliers, g(q) is the L×1 vector of algebraic constraints enforcing the constraints between bodies, and g′(q) is the L×n constraint matrix (gradient of g(q)).

Equations (2)-(4) represent a set of differential-algebraic equations (DAE's) for the trajectories of the MBD system. If only Eq. (2) needed to be satisfied, it would be a system of type 1 which can be solved via direct integration of an initial value problem (IVP), given consistent initial conditions, upon inversion of the augmented mass matrix in the left-hand side of Eq. (2). If both Eqs. (2) and (4) needed to be satisfied, then the system would be of type 2. Finally, if Eqs. (2) and (3) need to be satisfied, the system is of type 3. Note that Eq. (2) incorporates the second time derivative of the position level algebraic constraints of Eq. (3). The numerous existing MBD equation formulations differ only in the specific nature of the generalized position vector q and in the manner in which the DAE of Eqs (2)-(4) is solved. In all cases of spatial systems, the vector G(t,q,dq/dt) of generalized, applied and impressed forces contains quadratic dependencies on dq/dt.

If the system of bodies is connected together such that there is a main chain with “branches” but no closed loops, it is said to have tree topology. Otherwise, it is said to have closed loops. If the system has tree topology, it is possible to express it in minimal form by explicitly eliminating all hinge constraints and choosing minimal coordinates. To transform Eqs. (2)-(4) into minimal form, ignore the lower block (λ-block) of the block vector Eq. (2), as well as Eqs. (3) and (4). In this case, the problem reduces to that of solving a minimal DOF, linearly-implicit, second-order ordinary differential equation (ODE) given initial conditions. Since the mass matrix is positive definite, it is straightforward solve for the accelerations and then to convert the second-order ODE into a set of first-order ODE's, obtaining the classical initial value problem (IVP). If the system has closed loops, it is no longer possible to simplify the structure of Eqs. (2)-(4) and the descriptor or full descriptor forms both can be represented by these equations. The system is said to have descriptor form if some hinges are modeled by explicit algebraic constraints (e.g., the cut joints in closed loop systems), while the rest are modeled by minimal coordinates after explicit elimination of the constraints. The system has full descriptor form when all hinges are modeled by algebraic constraints (Eq. (3)).

For systems in descriptor or full descriptor form, the solution of the DAE is conceptually simple: first, solve for the accelerations and Lagrange multipliers by inverting the matrix on the left-hand side of Eq. (2); second, solve the associated IVP after converting the equations for the acceleration into first-order ODE form. If the system is of type 1 we are done, in principle. If the system is of type 3, solution of Eq. (2) is not sufficient to guarantee satisfaction of the constraint Eq. (3) due to numerical integration drift. Equation (3) can be enforced in a variety of ways ranging from projections of the solution of Eq. (2) into the constraint mainfold via nonlinear iterative solutions starting from a first guess usually given by the solutions of Eq. (2) to constraint stabilization of the type 1 equation solution. The more effective solutions require iterative solutions of Eq. (3).

Thus, the problem of solving the generic DAE of Eqs. (2)-(4) can be seen to be composed of three distinct stages: 1) solution of Eq. (2) for the acceleration and the Lagrange multipliers; 2) IVP integration; and, 3) iterative solution of Eq. (3) to enforce the constraints. As mentioned earlier, effective numerical solutions of the MBD equations of motion will account for the interrelationships between all three stages. The last two stages are the same as for classical MD, with the notable difference that this form of the IVP equations is fundamentally different.

Let us consider stage 1. The block matrix on the left-hand side of Eq. (2) can be shown to be non-singular if the constraints are non-redundant. Solution of the linear implicit method can be carried out directly on Eq. (2) using RSM or NSM with cost O(n+m)³. However, this matrix is very sparse and has a particular form that has been exploited to yield O(n+m) solutions (for tree topology, with O(nₗ³) for loops). MBO(N)D makes full use of these latest formulations to yield an O(n+m) algorithm for the solution of the dynamics. It should be pointed out that neither the O(n+m), nor the O(n+m)³ solutions require us to select a particular set of generalized coordinates and velocities. This choice, however, will affect the details of the particular formulation and, most importantly, will have a significant influence on the effectiveness of algorithms for stages 2 and 3.

A variety of well know integrators are used in the MBD field to solve stage 2. These range from the “workhorse” RK4 to implicit midpoint and other Backwards Differentiation Formulas (BDF) to Adams-Bashforth-Moulton and other Predictor-Corrector (P-C) methods. These integrators have proved adequate for typical MBD application where a relatively small number of DOF is integrated for a short time and high accuracy is the goal. High order integrators with multiple function evaluations are adequate. Symplecticness and time-reversibility have not been an issue. This clearly changes when MBD is applied to SMD. Now a minimal number of forcefield (FF) evaluations (namely, one per step), are required, while long-term stability and “closeness” to a nearby dynamical system is more important than accuracy to a given trajectory afforded by the higher orders. RK4 and P-C methods require four and two FF evaluations, respectively, while exhibiting poor long term stability. BDF methods are also costly due to the iterative solutions, which require multiple FF evaluations, and have been shown to be inferior to Verlet with SHAKE for classical MD applications.

The recent interest in symplectic integrators has lead applied mathematicians to formulate such integrators for rigid body systems. While promising, these integrators require a particulation artifact that is not readily extensible to flexible bodies. Other attempts at adapting classical MD integrators to MBD treatment of SMD rely on modifying Verlet-type integrators to account for the velocity dependent terms. Essentially, an inexact “splitting” between position and velocity variables is attempted in order to use the Verlet structure, and the velocity equations are iterated (see IVV, see VCD below.) Straightforward implementation of these iterative solutions does not result in an optimal implementation. It is necessary to carefully design an integrator that will retain the important properties of time-reversibility and (although harder to prove) symplecticness.

As discussed herein, the need for iterative solutions of the constraint equations (stage 3 for the MBD DAE solution) is common to both classical MD and MBD systems. Furthermore, similar techniques (eq. Newton-Raphson, Gauss-Seidel) can be used in both cases. The types of constraints that concern us for SMD systems are mainly limited to bond length constraints between bodies and atoms. This suggests that the applications of SHAKE-like GS iterations (modeled to include SOR) could be effective given a suitable optimal integrator.

### SUMMARY OF THE INVENTION

SMD is the next breakthrough step in the quest for more efficient MD simulations. The MBD formalism that enables SMD has unique characteristics that preclude straightforward modifications of classical MD integrators, while classical MBD integrators are not suitable for the unique requirements of MD. What is needed is an optimal integrator for SMD that will provide good of numerical properties while enabling the large timesteps that are the promise of SMD. The nature of the solutions to MBD equations of motion as described herein suggests that rather than a single optimal integrator, an integrator/formulation combination might be necessary. Lobatto-like integrators have not yielded significant improvements, suggesting that Lobatto is quasi-optimal for the current implementation of MB. Reformulations of the MBO(N)D equations, however, have resulted in significant improvements in the effectiveness of the integrator. A Lobatto or RKN variant using momentum variables (instead of velocity) resulted in marked improvements in the long-term stability of the integrator. This is not entirely surprising given that using momentum leads to the natural “splitting” of the underlying Hamiltonian, in manner similar to Verlet discretization of classical MD.

As will be described in more detail herein, the combination of this natural “splitting” of the Hamiltonian (using the Liouville formalism), together with a novel RESPA-like solution of the multibody equations of motion, enabled by the use of Euler parameters to describe body rotations, yields the most efficient, stable, MBD integrator/formulation solution for SMD systems.

The following description sets forth details of the development of a new Optimized MultiBody Integrator (OMBI) that dramatically improved MBO(N)D's performance. Specifically, the new OMBI allows for maintaining stability over longer duration simulation timescales, and further improves MBO(N)D's computational speed by at least 2-10 times. But most importantly, OMBI is able to significantly expand the scale of simulation problems to which MBO(N)D may be applied, and makes it possible to run MD simulations for large molecules (substructured into thousands of bodies) with large solvation systems (thousands of explicit water molecules). The new code with OMBI is referred to herein as MBO(N)D-II. In one aspect, the invention comprises a method of simulating multibody dynamics of a molecular system so as to produce output data representative of a time evolution of the molecular system. The method includes providing a set of equations for characterizing multibody dynamics of the molecular system. The set of equations is constrained by a constraining equation. The method further includes providing an integrator for integrating the set of equations. The integrator is tailored for the set of equations so as to satisfy the constraining equation. The method further includes applying the integrator to the set of equations over a time step, so as to produce output data representative of the time evolution of the molecular system relative to the time step.

Another embodiment of the invention further includes applying the integrator to the set of equations over a predetermined number of time steps, so as to produce output data representative of a time evolution of the molecular system relative to a time interval corresponding to the predetermined number of time steps.

In another embodiment of the invention, the constraining equation includes |e|=1.

In another embodiment of the invention, the set of equations for characterizing multibody dynamics includes equations of motion for each of a plurality of bodies in the system, the equations of motion given by

\dot{e}=W(ω)e

\dot{x}=C(e)u

\dot{ξ}=U_{ξ}

\dot{p}_{ω}=G_{ω}(q)+p^{T}[A_{ω}]p

\dot{p}ᵤ=Gᵤ(q)+p^{T}[Aᵤ]p

\dot{p}_{ξ}=G_{ξ}(q)+p^{T}[A_{ξ}]p

The matrices W(ω) and C(e) represent the kinematical relations and are written in the form

$$W ( ω ) = \frac{1}{2} [ \begin{matrix}0 & - {ω}_{x} & - {ω}_{y} & - {ω}_{z} \\ {ω}_{x} & 0 & {ω}_{z} & - {ω}_{y} \\ {ω}_{y} & - {ω}_{z} & 0 & {ω}_{x} \\ {ω}_{z} & - {ω}_{y} & - {ω}_{x} & 0\end{matrix} ] and , \\ C ( e ) = [ \begin{matrix}1 - 2 ( {e}_{2}^{2} + {e}_{3}^{2} ) & 2 ( {e}_{1} {e}_{2} + {e}_{3} {e}_{0} ) & 2 ( {e}_{1} {e}_{3} - {e}_{2} {e}_{0} ) \\ 2 ( {e}_{2} {e}_{1} - {e}_{3} {e}_{0} ) & 1 - 2 ( {e}_{3}^{2} + {e}_{1}^{2} ) & 2 ( {e}_{2} {e}_{3} + {e}_{1} {e}_{0} ) \\ 2 ( {e}_{3} {e}_{1} + {e}_{2} {e}_{0} ) & 2 ( {e}_{3} {e}_{2} - {e}_{1} {e}_{0} ) & 1 - 2 ( {e}_{1}^{2} + {e}_{2}^{2} )\end{matrix} ] , respectively .$$

Another embodiment of the invention further includes applying the integrator to the set of equations over a time step further includes propagating Euler parameters of the set of equations for characterizing multibody dynamics, according to the matrix exponential of e^{½}=E(ω^{½}) e⁰. Another embodiment of the invention further includes propagating a momentum vector to a half step t=Δt/2, while freezing one or more position states at t=0. The method further includes propagating a vector of rigid position variables to the half step t=Δt/2, while freezing one or more flexible position variables at t=0, and the momentum vector at t=Δt/2. The method also includes propagating the vector of flexible position variables to the full step t=Δt using momenta, recomputed in modal velocities, at t=Δt/2, propagating the vector of rigid position variables to the full step t=Δt, while freezing the flexible position variables at t=Δt and the momentum vector at t=Δt/2. The method also includes propagating the momentum vector to the full step t=Δt freezing the position states at t=Δt.

Another embodiment of the invention further includes decomposing the set of equations for characterizing multibody dynamics first with respect to momentum states, and then with respect to position and rigid and flexible degrees of freedom.

Another embodiment of the invention further includes decomposing the set of equations for characterizing multibody dynamics first with respect to rigid and flexible degrees of freedom, and then with respect to position and momentum states.

Another embodiment of the invention further includes solving a kinematic equation associated with the set of equations for characterizing multibody dynamics via a solution based on a matrix exponential of the form

$$E ( {ω}_{1 / 2} ) = {ⅇ}^{{w}_{( {ω}_{1 / 2} )} \frac{Δ t}{2}} = cos ( γΔ t ) I + sin ( γΔ t ) D .$$

In another aspect, the invention comprises a computer system for simulating multibody dynamics of a molecular system so as to produce output data representative of a time evolution of the molecular system. The computer system includes an analytical structure for characterizing multibody dynamics of the molecular system, wherein the analytical structure is constrained by a constraining equation. The computer system further includes an integrator for integrating the analytical structure, wherein the integrator is tailored for the structure so as to satisfy the constraining equation. The integrator integrates the structure over a time step, so as to produce output data representative of a time evolution of the molecular system relative to the time step.

In another embodiment, the analytical structure includes a set of equations modeled in a computer code.

In another aspect, the invention comprises a computer system for simulating multibody dynamics of a molecular system so as to produce output data representative of a time evolution of the molecular system. The computer system includes means for characterizing multibody dynamics of the molecular system, wherein the analytical structure is constrained by a constraining equation. The system further includes means for integrating the analytical structure, wherein the integrator is tailored for the structure so as to satisfy the constraining equation. The means for integrating integrates the structure over a time step, so as to produce output data representative of a time evolution of the molecular system relative to the time step.

### BRIEF DESCRIPTION OF DRAWINGS

The foregoing and other objects of this invention, the various features thereof, as well as the invention itself, may be more fully understood from the following description, when read together with the accompanying drawings in which:

FIG. 1 shows a block flow diagram of the OMBI algorithm for particles;

FIG. 2 shows a block flow diagram of the OMBI algorithm for rigid bodies; and,

FIG. 3 shows a geometrical interpretation of vectors used in momentum constraint.

### DESCRIPTION OF THE PREFERRED EMBODIMENTS

The derivation of the OMBI is based on the Liouville-Trotter formalism (see Tuckerman M., Beme B. J., and Martyna G. J., J. Chem. Phys., 97, 3, p. 1990-2001 (1992)), which enables time-symmetric decomposition of equations of motion with respect to the position and velocity states as well as with respect to different DOF of the system. In the theory of differential equations this formalism is also evidenced as a method of symmetric successive freezing of the system's variables. Each of the systems arising as a result of this decomposition is the subject for analytical integration within the time step at which decomposition was performed. In this way, the Liouville-Trotter mechanism provides the framework for integrating complex nonlinear systems for which obtaining analytical solutions would be impossible. The resulting integrator is still numerical but with the built-in analytical solutions for the decomposed systems. Due to the time-symmetric nature of the Trotter decomposition, the integrator is time-reversible which results in high performance during long-time simulations. Since the Trotter decomposition still involves some approximation, the art of designing the optimized multibody integrator consists in finding such a formulation for the equations of motion that has the largest degree of natural decomposition in the system's variables and is rich in its analytical properties. It was found that the formulation using Euler parameters and momentum variables, with the definition of the momentum in the body frame, is the most suitable formulation, which meets the above requirements. The Liouville-Trotter formalism may be generalized for this formulation to deal with the fact that the equations of motion are not of second-order.

In implementing the Liouville-Trotter formalism we exploited the analytical advantages of the formulation with Euler parameters and momentum variables. First of all, the definition of the momentum in the body-fixed axis system uncouples position and velocity states in the equation for momentum as much as possible. This makes the Trotter decomposition more accurate. In addition, the fact that all functional dependencies in the equations of motion for this formulation are either linear (e.g., kinematics for Euler parameters) or quadratic (e.g., gyroscopic coupling effects) was exploited. Correspondingly, in the first case the matrix exponential is needed to propagate the states of the linear system. In the second case, we implemented an additional Trotter decomposition of a vector differential equation and solved the resulting scalar Riccati-type equations analytically at the integration time step.

The detailed form of the OMBI for a general case, which includes rotational, translational and deformational (due to flexibility) DOF is given in the subsections below.

The equations of motion with the Euler parameters parametrization for rotations are represented in the form

\dot{q}=V(q,p)

\dot{p}=G(q,p) (5)

Here, the

$$( 7 N + {\sum }_{i = 1}^{N} {m}_{i} ) \times 1$$

state vector q consists of N blocks, where N is the number of bodies in the system and mᵢ is the number of modes in the i-th body:

$$q = ( \begin{matrix}{q}_{1} \\ {q}_{2} \\ ⋮ \\ {q}_{N}\end{matrix} ) \qquad ( 6 )$$

Each block of the vector q has the following structure (the index i, which numbers the bodies in the system, is omitted for simplicity):

$${q}_{i} = ( \begin{matrix}e \\ x \\ ξ\end{matrix} ) \qquad ( 7 )$$

where e is the 4×1 vector of Euler parameters, x is the 3×1 vector which represents the translational motion of the body's center of mass (COM), and ξ is the mᵢ×1 vector of modal coordinates which model the body's deformation.

The vector p is the

$$( 6 N + {\sum }_{i = 1}^{N} {m}_{i} ) \times 1$$

vector of momenta which also comprises N blocks (for each body in the system):

$$p = ( \begin{matrix}{p}_{1} \\ {p}_{2} \\ ⋮ \\ {p}_{N}\end{matrix} ) \qquad ( 8 )$$

where each block is defined by an equation:

$$( \begin{matrix}{p}_{ω} \\ {p}_{u} \\ {p}_{ξ}\end{matrix} ) = M ( ξ ) ( \begin{matrix}ω \\ u \\ {U}_{ξ}\end{matrix} ) \qquad ( 9 )$$

Here, the mass matrix of the i-th body is expressed in a general non-diagonal block form as

$$M ( ξ ) = [ \begin{matrix}I ( ξ ) & S ( ξ ) & d ( ξ ) \\ S ( ξ ) & M & a ( ξ ) \\ {d}^{T} ( ξ ) & {a}^{T} ( ξ ) & e ( ξ )\end{matrix} ] \qquad ( 10 )$$

where I(ξ) is the 3×3 inertial tensor of the body, M is the 3×3 diagonal mass matrix of the body, e(ξ) is the mⁱ×mⁱ modal mass matrix, and the blocks S, d, and a represent the corresponding couplings between the diagonal blocks of the mass matrix M(ξ). A general dependency of the body's matrix on its deformation is formalized by a dependency on the modal coordinates ξ.

The vector of absolute velocities for the i-th body has the following block structure:

$${U}_{i} = ( \begin{matrix}ω \\ u \\ {U}_{ξ}\end{matrix} ) = ( \begin{matrix}{ω}_{x} \\ {ω}_{y} \\ {ω}_{z} \\ u \\ v \\ w \\ {U}_{{ξ}_{1}} \\ ⋮ \\ {U}_{{ξ }_{m}}\end{matrix} ) \qquad ( 11 )$$

where ω is the 3×1 vector of the body's angular velocities projected onto the body frame, u is the 3×1 vector of the translational velocities of the body's COM projected onto the body frame, and U_{ξ}is the mᵢ×1 vector of modal velocities.

The

$$( 6 N + {\sum }_{i = 1}^{N} {m}_{i} ) \times 1$$

vector G(q,p) formalizes all forces acting on each generalized coordinate. This vector is defined by

$$G = {G}_{FF} + \tilde{Ω} MU + \frac{1}{2} {U}^{T} [ M {,}_{j} ] U \qquad ( 12 )$$

where the first term, G_{FF} (q), represents the contribution from forcefield interactions. The second term accounts for gyroscopic coupling effects (the matrix \tilde{Ω} is an assembly of three skew matrices for the rotational and translational velocity vectors which models the coupling of rotational and translational motion). The third term accounts for forces due to the deformation-dependency of the mass matrix (thereby, what is meant by [M,ⱼ] is the partial derivative of each element of M(ξ) with respect to the j-th generalized coordinate). The functional dependency V(q,p) represents the kinematical ties between the system's generalized coordinates and velocities corresponding to the Euler parameter formulation of multibody dynamics.

Taking the above into account we will use the following block-vector form of the equations of motion for each body in the system (omitting for simplicity the index I which numbers bodies):

\dot{e}=W(ω)e

\dot{x}=C(e)u

\dot{ξ}=U_{ξ}

\dot{p}_{ω}=G_{ω}(q)+p^{T}[A_{ω}]p

\dot{p}ᵤGᵤ(q)+p^{T}[Aᵤ]p

\dot{p}_{ξ}=G_{ξ}(q)+p^{T}[A_{ξ}]p (13)

Here, the matrices W(ω) and C(e) represent the kinematical relations and are written in the form:

$$\begin{matrix}W ( ω ) = \frac{1}{2} [ \begin{matrix}0 & - {ω}_{x} & - {ω}_{y} & - {ω}_{z} \\ {ω}_{x} & 0 & {ω}_{z} & - {ω}_{y} \\ {ω}_{y} & - {ω}_{z} & 0 & {ω}_{x} \\ {ω}_{z} & - {ω}_{y} & - {ω}_{x} & 0\end{matrix} ] & ( 14 ) \\ C ( e ) = [ \begin{matrix}1 - 2 ( {e}_{2}^{2} + {e}_{3}^{2} ) & 2 ( {e}_{1} {e}_{2} + {e}_{3} {e}_{0} ) & 2 ( {e}_{1} {e}_{3} - {e}_{2} {e}_{0} ) \\ 2 ( {e}_{2} {e}_{1} - {e}_{3} {e}_{0} ) & 1 - 2 ( {e}_{3}^{2} + {e}_{1}^{2} ) & 2 ( {e}_{2} {e}_{3} + {e}_{1} {e}_{0} ) \\ 2 ( {e}_{3} {e}_{1} + {e}_{2} {e}_{0} ) & 2 ( {e}_{3} {e}_{2} - {e}_{1} {e}_{0} ) & 1 - 2 ( {e}_{1}^{2} + {e}_{2}^{2} )\end{matrix} ] & ( 15 )\end{matrix}$$

Note that the matrix W(ω) has been evaluated by a linear transformation of the original Euler parameter kinematics equation \dot{e}=Q(e)ω so that W(ω)e=Q(e)ω. The matrix C(e) is a rotation matrix from the body frame to the inertial frame. The tensors [A_{ω}], [Aᵤ], and [A_{ξ}] symbolically represent quadratic dependency on the velocity (momentum) factor in the equations of multibody dynamics. The computational scheme for realization of p^{T}[A]p accounts for sparsity of the tensor [A].

It should also be mentioned that in the above dynamical equations the transformation of the momentum vector p into the velocity vector U is realized by a solving a system of linear equations p=M (ξ)U.

The derivation of the OMBI is based on the Lioville-Trotter formalism (RESPA-type approach). The Lioville-Trotter formalism decomposes the original system of differential equations into a number of smaller subsystems integration of which is simpler than integration of the original system (for example, each subsystem can be integrated analytically). The important property of the Trotter decomposition consists in the fact that it is time-symmetric which results in high accuracy of the resulting integration algorithm.

For the case of dynamics of a system of flexible bodies the following Trotter decomposition may be used:

$$U ( t ) = {e}^{iL Δ t} = {e}^{{iL}_{p} Δ \frac{t}{2}} {e}^{{iL}_{q} Δ t} {e}^{{iL}_{p} Δ \frac{t}{2}} + O ( Δ {t}^{3} ) \qquad ( 16 )$$

where the position Liouville operator is defined as

$${iL}_{q} = \dot{q} \frac{\partial }{\partial q} \qquad ( 17 )$$

and the momentum Liouville operator as

$${iL}_{p} = \dot{p} \frac{\partial }{\partial p} \qquad ( 18 )$$

In its turn the position Liouville operator may be decomposed into parts corresponding to the rigid (z) and flexible (ξ) degrees of freedom (DOF):

$${iL}_{q} = {iL}_{z} + {iL}_{ξ} = \dot{z} \partial + \dot{ξ} \partial \qquad ( 19 )$$

Correspondingly, the following Trotter decomposition may be performed as:

$${ⅇ}^{i {L}_{q} Δ t} = {ⅇ}^{i {L}_{z} \frac{Δ t}{2}} {ⅇ}^{i {L}_{ξ} Δ t} {ⅇ}^{i {L}_{z} \frac{Δ t}{2}} + O ( Δ {t}^{3} ) \qquad ( 20 )$$

It is important to note that other Trotter decompositions are possible in order to obtain a time-symmetric integrator. For example, the system may be decomposed first with respect to rigid and flexible DOF and only then each sub-system can be decomposed with respect to position and momentum states. This decomposition makes it possible to utilize the analytical solution for harmonic oscillator (in the case when flexibility is modeled by using a linearizied system of equations with the corresponding stiffness matrix). However, the drawback of this Trotter decomposition is in the fact that two evaluations of the forcefield are needed per integration step (each forcefield evaluation corresponds to the previous and updated deformations of the body). The present Trotter decompositions of Eq. (13) are advantageous in terms that only one position-dependent operation per step is needed. This includes one forcefield evaluation and one factorization of the mass matrix M(ξ) to solve M (ξ)U=p for U. Moreover, the chosen decomposition is suitable for treating the body's flexibility in a general (not necessarily linear) form.

According to the Trotter decomposition presented above, the Optimized Multibody Integrator (OMBI) includes five stages, which formalize the following operations.

Stage 1. Propagate the momentum vector to the half step t=Δt/2 freezing the position states at t=0:

$$\dot{p} = G ( {q}_{0} , p ) , t ∈ ( 0 , \frac{Δ t}{2} ) \qquad ( 21 )$$

with initial conditions p(0)=p₀.

Stage 2. Propagate the vector of rigid position variables to the half step t=Δt/2 freezing the flexible position variables at t=0 and the momentum vector at t=Δt/2:

$$\dot{z} = {V}_{z} ( z , {ξ}_{0} , {p}_{1 / 2} ) , t ∈ ( 0 , \frac{Δ t}{2} ) \qquad ( 22 )$$

with initial conditions z(0)=z₀.

Stage 3. Propagate the vector of flexible position variables to the full step t=Δt using momenta (recomputed in modal velocities) at t=Δt/2:

\dot{ξ}=U_{ξ}_{_{½}}, tε(0,Δt) (23)

with initial conditions ξ(0)=ξ₀.

Stage 4. Propagate the vector of rigid position variables to the full step t=Δt freezing the flexible position variables at t=Δt and the momentum vector at t=Δt/2:

$$\dot{z} = {V}_{z} ( z , {ξ}_{1} , {p}_{1 / 2} ) , t ∈ ( \frac{Δ t}{2} , Δ t ) \qquad ( 24 )$$

with initial conditions

$$z ( \frac{Δ t}{2} ) = {z}_{1 / 2} .$$

Stage 5. Propagate the momentum vector to the full step t=Δt freezing the position states at t=Δt:

$$\dot{p} = G ( {q}_{1} , p ) , t ∈ ( \frac{Δ t}{2} , Δ t ) \qquad ( 25 )$$

with initial conditions

$$p ( \frac{Δ t}{2} ) = {p}_{1 / 2} .$$

It is important to note that for the particular case of ideal rigid bodies (ξ±0) the OMBI is comprised of only 3 stages since stages 2, 3, and 4 become unified in one single stage (to propagate the vector of rigid positions to the full step). In the general flexible case the body is symmetrically rigidized over each half of the time step. In this way, as was mentioned above, the particular Trotter decomposition used for the derivation of the OMBI ensures that all position-dependent operations, such as forcefield evaluations are performed only once at each integration step (assuming that the position-dependent operation at the beginning of the step coincides with the operation at the end of the previous step). From a physical point of view, this integration scheme results in position-dependent operations being performed for the bodies, which are in their initial deformation at the beginning of the step and in their final deformation at the end of the step.

The following subsection provides concretizations of the OMBI stages by describing how the integration of each subsystem is carried out, either analytically or numerically. Note that the following derivations are the heart of the OMBI since they define the efficiency of the integration process and require some effort in finding elegant analytical solutions.

These stages are defined by similar equations (21) and (22). All notations here correspond to Eq. (22) i.e. for Stage 2. Note that for Stage 4 one has to make the substitutions ξ₀→ξ₁ and

$$( 0 , \frac{Δ t}{2} ) \to ( \frac{Δ t}{2} , Δ t ) .$$

The equations in Stages 2 and 4 define the kinematics of the rigidized body with velocities frozen at the midpoint of the time interval and have the form (in block-vector notations):

\dot{e}=W(ω_{½})e

\dot{x}=C(e)u_{½} (26)

First, the equation for propagating the Euler parameters, to the half step is considered. This is a linear equation and its solution is based on the matrix exponential:

e_{½}=E(ω_{½})e₀ (27)

An elegant form of this matrix exponential E was found. The derivation of the matrix exponential is based on its Taylor expansion with further analytical summation of the series exploiting the fact that the matrix W is skew-symmetric. To the best of our knowledge, this result appears to be new in the literature. According to our derivations, the matrix exponent can be written in the form:

$$E ( {ω}_{1 / 2} ) = {ⅇ}^{{w}_{( {ω}_{1 / 2} )} \frac{Δ t}{2}} = cos ( γΔ t ) I + sin ( γΔ t ) D \qquad ( 28 )$$

where

$$γ = \frac{1}{4} \vert {ω}_{1 / 2} \vert \qquad ( 29 )$$

is the magnitude of the vector of angular velocities ω (at the half step) projected onto the body frame,

$$I = [ \begin{matrix}1 & 0 & 0 & 0 \\ 0 & 1 & 0 & 0 \\ 0 & 0 & 1 & 0 \\ 0 & 0 & 0 & 1\end{matrix} ] \qquad ( 31 )$$

is the identity matrix,

$$D = [ \begin{matrix}0 & {\overline{ω}}_{x} & {\overline{ω}}_{y} & {\overline{ω}}_{z} \\ {\overline{ω}}_{x} & 0 & {\overline{ω}}_{z} & {\overline{ω}}_{y} \\ {\overline{ω}}_{y} & {\overline{ω}}_{z} & 0 & {\overline{ω}}_{x} \\ {\overline{ω}}_{z} & {\overline{ω}}_{y} & {\overline{ω}}_{x} & 0\end{matrix} ] \qquad ( 32 )$$

is a skew-symmetric matrix of the vector of directional cosines. Note that the directional cosines \overline{ω} define the orientation of the vector of angular velocities ω in the body frame and computed as

$$\overline{ω} = \frac{{ω}_{1 / 2}}{\vert {ω}_{1 / 2} \vert} \qquad ( 33 )$$

The second step in realizing the kinematics equations is to propagate the translational coordinates for the body's COM. The corresponding propagator was expressed in a very simple analytical form (using the analytical solution for the matrix exponent of Eq. (28) and the quadratic dependency of the rotation matrix C(e) on the vector of Euler parameters e, see Eq. (15)):

X_{½}=X₀+Λu_{½} (34)

where

$$\begin{matrix}Λ = [ \begin{matrix}1 - 2 ( {Δ}_{22} + {Δ}_{33} ) & 2 ( {Δ}_{12} - {Δ}_{03} ) & 2 ( {Δ}_{13} + {Δ}_{02} ) \\ 2 ( {Δ}_{12} + {Δ}_{03} ) & 1 - 2 ( {Δ}_{11} + {Δ}_{13} ) & 2 ( {Δ}_{23} - {Δ}_{01} ) \\ 2 ( {Δ}_{13} - {Δ}_{02} ) & 2 ( {Δ}_{23} + {Δ}_{01} ) & 1 - 2 ( {Δ}_{11} + {Δ}_{22} )\end{matrix} ] & ( 35 ) \\ Δ = {μ}_{0} [ {e}_{0} {e}_{0}^{T} ] + {μ}_{CS} [ {e}_{0} {b}_{0}^{T} + {b}_{0} {e}_{0}^{T} ] + {μ}_{S} [ {b}_{0} {b}_{0}^{T} ] & ( 36 ) \\ {b}_{0} = {De}_{0} & ( 37 ) \\ {μ}_{c} = \frac{Δ t}{4} + \frac{sin ( 2 γΔ t )}{8 γ} & ( 38 ) \\ {μ}_{s} = \frac{Δ t}{4} - \frac{sin ( 2 γΔ t )}{8 γ} & ( 39 ) \\ {μ}_{cs} = \frac{{[ sin ( γΔ t ) ]}^{2}}{4 γ} & ( 40 )\end{matrix}$$

The OMBI's propagator of Eq. (27) for Euler parameters has an important practical property which consists in the fact that the propagator ensures exact (up to machine accuracy) maintenance of the constraint |e|=1.

To prove this fact, it is sufficient to show that the matrix exponential e^{W} (where

$$W = W ( {ω}_{1 / 2} ) \frac{Δ t}{2}$$

for simplicity) is an unitary matrix and, thus, retains the length of the vector e: |e_{½}|=|e₀|. The proof is based on the following two equalities:

[ₑ^{W}]⁻¹=ₑ^{W} (41)

which is due to the property of stationarity of the differential equation for e (assuming that W (ω_{½}) is “frozen”), and

−W=W^{T} (42)

which is due to the fact that W is skew-symmetric. Based on the above two equalities it is easy to show that

[e^{W}]⁻¹=e^{-W}=e^{W}^{^{T}}=[e^{W}]^{T} [symbol] |e_{½}|=|e₀| (43)

Our tests during the Phase II work confirmed that the OMBI maintains the constraint on the length of the Euler parameter vector up to machine accuracy over hundreds of thousands of time steps and beyond (even using large time steps within the stability limits).

It should be noted that conventional (non-model based) integrators (e.g., Runge-Kutta etc.) involve a certain truncation error which quickly results in a build-up of error in the vector of Euler parameters e (at hundreds of time steps, even if those steps are relatively small). Usually, some artificial normalization of the Euler parameter vector are used to maintain the constraint |e|=1. The OMBI, which is directly tailored for the equations of multibody dynamics, easily obviates this difficulty and makes Euler parameters even more attractive for these applications.

The realization of stage 3, i.e. the propagation of the vector of modal coordinates to the full step, is trivial (due to frozen U_{ξ}_{_{½}}in Eq. (23)):

ξ₁=ξ₀+U_{ξ}_{_{½}}Δt (44)

The realization of stages 1 and 5 involves solving the Riccati-type (i.e., quadratic) equation for the momentum vector p:

\dot{p}=G(q₀)+p^{T}[A]p (45)

First of all, it is important to stress that this equation is for a general case of flexible bodies and its analytical solution over an arbitrary time interval is problematic. Note that the analytical solution remains difficult even for the case of rigid-body torque-free rotation when the quadratic dependency on momentum takes a particular form p×(I⁻¹p) and G=0. In the latter case the solution may be expressed in terms of the Jacobi elliptic functions (which require tabulation). That is why it was decided not to search for a general analytical solution of Eq. (45) in closed vector form for an arbitrary time interval, but instead to find a numerical algorithm for solving Eq. (45) at the time step Δt.

We developed a scalar version of the propagator for Eq. (45). This version is based on further time-symmetric decomposition of the Liouville operator with respect to each DOF. A general idea of this decomposition may be illustrated by the following example. Let the integration of the n-dimensional system of Eq. (45) be performed at the half step in accordance with the following Liouville-Trotter formalism:

$$e ( {\sum }_{i = 1}^{n} {iL}_{i} ) \frac{Δ t}{2} = [ {\prod }_{i = 1}^{n - 1} {e}^{{iL}_{i} \frac{Δ t}{4}} ] [ {e}^{{iL}_{n} \frac{Δ t}{2}} ] [ {\prod }_{i = 1}^{n - 1} {e}^{{iL}_{i} \frac{Δ t}{4}} ] + 0 ( Δ {t}^{3} ) \qquad ( 46 )$$

From a physical point of view, Eq. (46) entails that the 1st DOF is integrated over a quarter of the step with other DOF being frozen, then the 2nd DOF is integrated at the quarter of the step while the other DOF are frozen and so on. This process is continued until the (n−1)^{th} DOF is integrated. Then the n^{th} DOF is integrated at the half step (all other DOF are being kept frozen). After that the process of integrating the first (n−1) DOF over a quarter of the time step is repeated in reverse order (starting from the (n−1)th DOF). As can be seen, the above computational cycle is time-symmetric.

The realization of the operation for each DOF can be considered as the integration of a scalar Riccati equation

\dot{p}=ap²+bp+c (47)

Eq. (47) can be easily solved through transformation into a two-dimensional Hamiltonian system.

The final result can be written in the closed form:

$$p ( t ) = [ \begin{matrix}\frac{\sqrt{Δ} tan [ {tan}^{- 1} \frac{2 ap ( 0 ) + b}{\sqrt{Δ}} + \frac{\sqrt{Δ}}{2} t ] - b}{2 a} if Δ > 0 \\ \frac{\sqrt{Δ} tanh [ {tanh}^{- 1} \frac{2 ap ( 0 ) + b}{\sqrt{- Δ}} - \frac{\sqrt{- Δ}}{2} t ] - b}{2 a} if Δ < 0\end{matrix} \qquad ( 48 )$$

where Δ=4ac−b².

This algorithm can be easily programmed, by forming coefficients a, b, and c for each scalar differential equations and then using Eq. (48) to propagate the current DOF forward in time. The simulations in MBO(N)D demonstrate that the propagator of Eq. (48) exactly presumes the time symmetry of the entire integration process.

The main objective here is to implement OMBI (Optimal Multi-Body Integrator), i.e., formulate it in a form of requirements for the design of the OMBI code in the OO C++ MBO(N)D (MBO(N)D-II). OMBI is formulated herein for the case of multi-body dynamics in the absolute coordinate system. The OMBI integrator may be first implemented for the case when: 1) the multi-body system includes particles and rigid bodies; 2) rotation of each rigid body is modeled by four Euler parameters; 3) momenta (not velocities) are used as the state-vector elements; and 4) there are no inter-body constraints (only inter-body interactions).

The OMBI algorithm propagates dynamics of interacting particles and rigid bodies at a single integration step, Δt. OMBI, designed to provide optimal accuracy and stability of integration, is tailored for a particular formulation of unconstrained multibody dynamics, which uses Euler parameters and momenta (for rigid bodies). Correspondingly, the integration process is performed in an explicit form.

The OMBI algorithm (for particles and rigid bodies) described in this document contains reusable functions, which are also utilized in the OMBI algorithm (with flexible bodies) and in the OMBI algorithm with SHAKE-type constraints. These functions are described in a form amenable for their reuse.

Unlike the Lobatto integrator, which is a general purpose algorithm for a second-order system, OMBI is tailored to a particular form of dynamic equations. This is especially important for integrating dynamics of rigid bodies. However, OMBI for particles should follow this formalism for the sake of universality. Correspondingly, the dynamics of a particle are described in the following form:

$$\dot{q} = V ( p ) \\ \dot{p} = {[ {G}_{FF}^{abs} ( q ) ]}_{f} \qquad ( 49 )$$

Note that Eq. (49) uses momenta rather than velocities (as in the dynamics of particles for the Stage 1 Lobatto integrator. The following notations are used in Eq. (49): q is the 3×1 vector of generalized coordinates to formalize the particle's translational positions in the absolute coordinate system, p is the 3×1 vector of generalized momenta, V(•) is a 3×1 vector of generalized velocities (as a function of generalized momenta), and [G_{FF}^{abs}(•)]_{f} is the 3×1 vector of generalized forces (external force applied to a particle and expressed in the absolute coordinate system).

In a more detail, the vector of generalized coordinates for a particle is the following:

$$q = r = ( \begin{matrix}x \\ y \\ z\end{matrix} ) \qquad ( 50 )$$

where the 3×1 vector r represents the position of a particle in the absolute Cartesian coordinate system.

Correspondingly, the vector of generalized momenta takes a form:

$$p = {p}_{v} = ( \begin{matrix}{p}_{{v}_{x}} \\ {p}_{{v}_{y}} \\ {p}_{{v}_{z}}\end{matrix} ) \qquad ( 51 )$$

where pᵥ is the 3×1 momenta vector of a particle in the absolute coordinate system.

As was mentioned above, OMBI (specifically, its rigid-body version considered in this document) is tailored for the specific dynamic equations expressed in the form:

$$\dot{q} = V ( q , p ) \\ \dot{p} = G ( q , p ) \qquad ( 52 )$$

Eq. (52) formalizes dynamics of a rigid body in a multi-body system where bodies are not constrained but interact with each other (and with particles). The following notations are used in Eq. (52): q is the vector of generalized coordinates to formalize the body's translational and rotational positions in the absolute coordinate system, p is the vector of generalized momenta, V(•) is a nonlinear vector-function formalizing kinematic relations (generalized velocities), and G(•) is the vector of generalized forces.

The following composition of the 7×1 vector of generalized coordinates, q, is used

$$q = ( \frac{r}{e} ) \qquad ( 53 )$$

where

$$r = ( \begin{matrix}x \\ y \\ z\end{matrix} ) \qquad ( 54 )$$

is the 3×1 vector of coordinates for the body-frame origin in the absolute coordinate system, and

$$e = ( \begin{matrix}{e}_{0} \\ {e}_{1} \\ {e}_{2} \\ {e}_{3}\end{matrix} ) \qquad ( 55 )$$

is the 4×1 vector of Euler parameters describing orientation of the body in the absolute coordinate system.

Note that the formulation of OMBI for rigid bodies requires that the body-frame origin is chosen in the body's COM (Center Of Mass) and the body-frame axes are the principal axes.

The following vector of generalized momenta is associated with the position vector of Eq. (53):

$$p = ( \frac{{p}_{v}}{{p}_{ω}} ) \qquad ( 56 )$$

where

$${p}_{v} = ( \begin{matrix}{p}_{{v}_{x}} \\ {p}_{{v}_{y}} \\ {p}_{{v}_{z}}\end{matrix} ) \qquad ( 57 )$$

is the 3×1 vector of translational momenta projected on the axes of the absolute coordinate system, and

$${p}_{ω} = ( \begin{matrix}{p}_{{ω}_{x}} \\ {p}_{{ω}_{y}} \\ {p}_{{ω}_{z}}\end{matrix} ) \qquad ( 58 )$$

is the 3×1 vector of angular (rotational) momenta projected on the body-frame axes.

Note that the translational momenta are expressed in the absolute coordinate system while the rotational momenta are expressed in the body-frame. This is convenient in terms of providing a larger degree of separation between translational and rotational motions for rigid body (which, in its turn, helps to optimize the integrator).

Details of nonlinear functions V(•) and G(•) are omitted here. This document provides only the final integration algorithm, which integrates those functions in an explicit form. The following is a list of definitions for Inputs (for particles and bodies) to the algorithm:

q₀ is the vector of generalized coordinates at the beginning of the time step (marked by 0), size 7×1 (the first 3 components are Cartesian coordinates of the body's COM or of the particle and the second 4 components are Euler parameters).

Note: In the case of particle, the vector q₀ includes only the first 3 components.

p₀ is the vector of generalized momenta at the beginning of the time step (marked by 0), size 6×1 (the first 3 components are translational momenta and the second 3 components are rotational momenta).

Note: In the case of particle, the vector p₀ includes only the first 3 components.

Δt is the time step.

m is the mass of particle or body.

I_{b} is the vector of the body's principal inertia (Iₓ, I_{y}, I_{z}), size 3×1.

K_{b} is the vector of the body's inertia coefficients (Kₓ, K_{y}, K_{z}), size 3×1.

Note: The vector K_{b} is transformed from the vector I_{b}.

The following is a list of definitions for Outputs (for particles and bodies) to the algorithm:

q₁ is the vector of generalized coordinates at the end of the time step (marked by 1), size 7×1 (same components as for q₀).

p₁ is the vector of generalized momenta at the end of the time step (marked by 1), size 6×1 (same components as for p₀).

The following is a definition for an external operation (for particles and bodies) of the algorithm:

G_{FF}^{abs} (q) is a forcefield component of the generalized force (i.e. external force) in the absolute coordinate system as a function of position q, size 6×1 (the first 3 components are translational forces and the second 3 components are torques).

Note: In the case of particle, the vector G_{FF}^{abs} includes only the first 3 components.

The initialization algorithm for OMBI is described separately for particles and bodies in order to highlight similarity of some operations and difference of other operations (when one works with a particle or a rigid body). The design of the OMBI initialization module in the OO C++ code should combine these operations when it is possible.

The following initialization operation is needed in order to start OMBI for particles. Note that these initialization operation is in addition to the initialization operations performed by the FORTRAN MBO(N)D code (MBO(N)D-I). This additional initialization operation is needed due to OMBI's specifics (momenta).

Transform the vector of initial translational velocities V into the vector of translational momenta pᵥ:

$$( \begin{matrix}{p}_{{v}_{x}} \\ {p}_{{v}_{y}} \\ {p}_{{v}_{z}}\end{matrix} ) = ( \begin{matrix}{m}_{p} {V}_{x} \\ {m}_{p} {V}_{y} \\ {m}_{p} {V}_{z}\end{matrix} ) \qquad ( 59 )$$

where Vₓ, V_{y}, and V_{z} are projections of the vector of the particle's initial translational velocities V onto the axes of the absolute coordinate system, and mₚ is the mass of the particle.

The following initialization operations are needed in order to start OMBI for rigid bodies. Note that these initialization operations are in addition to the initialization operations performed by the FORTRAN MBO(N)D code. These additional initialization operations are needed due to OMBI's specifics: 1) the use of principal axes for setting the body-frame (instead of an arbitrary oriented body-frame); 2) the use of Euler parameters (instead of Euler angles); and, 3) the use of momenta (instead of velocities).

Additional Initialization Operations due to Principal Axes Shift Body-Frame Origin to Body's COM

In the general MBO(N)D formulation the body-frame origin is normally not in the body's COM. So, in order to initialize OMBI, one needs to shift the body-frame origin to the COM. This is performed via the following sequence of operations.

1) Compute the body's COM (Center Of Mass) in the body-frame, Δr_{COM}:

$$Δ {r}_{COM} = \frac{{\sum }_{j ∈ B} {{m}_{j}^{atm} [ {\overline{r}}_{j}^{nom} ]}^{*}}{{m}_{b}} \qquad ( 60 )$$

where [\overline{r}ⱼ^{nom}]* is the vector of Cartesian coordinates of the j-th atom defined in the original body-frame (before its shift to COM), mⱼ^{atm} is the mass of the j-th atom, m_{b} is the mass of the body. Compute the new coordinates of atoms in the shifted body-frame:

\overline{r}ⱼ^{nom}=[\overline{r}ⱼ^{nom}]*−Δr_{COM} (61)

Note that these coordinates are needed for external operation to compute external force in OMBI.

Compute New Inertia Tensor (in the Shifted Body-Frame)

The new inertia tensor, (I_{b})**, is defined with respect to the body's COM and can be computed via the following sequence of operations.

1) Compute the shifted inertia, i.e. the inertia which are associated with the shift of the body-frame to the body's COM by the vector Δr_{COM}:

ΔIₓₓ=m_{b}[(Δy_{COM})²+(Δz_{COM})²]

ΔI_{xy}=m_{b}[(Δx_{COM})(Δy_{COM})]

ΔI_{xz}=m_{b}[(Δx_{COM})(Δz_{COM})]

ΔI_{yy}=m_{b}[(Δx_{COM})²+(Δz_{COM})²]

ΔI_{yz}=m_{b}[(Δy_{COM})(Δz_{COM})]

ΔI_{zz}=m_{b}[(Δx_{COM})²+(Δy_{COM})²] (62)

where Δx_{COM}, Δy_{COM}, and Δz_{COM} are the components of the vector Δr_{COM}, and m_{b} is the mass of the body.

2) Assemble the shifted inertia tensor

$$Δ I = ( \begin{matrix}Δ {I}_{xx} & - Δ {I}_{xy} & - Δ {I}_{xz} \\ - Δ {I}_{xy} & Δ {I}_{yy} & - Δ {I}_{yz} \\ - Δ {I}_{xz} & - Δ {I}_{yz} & Δ {I}_{zz}\end{matrix} ) \qquad ( 63 )$$

3) Compute the new inertia tensor (I_{b})**:

[I_{b}]**=[I_{b}]*−ΔI (64)

Compute Principal Inertia and Rotation to Principal Axes

1) Perform eigenvalue decomposition of the non-diagonal inertia tensor (for each body):

(I_{b})**=Λ·diag(I_{b})Λ^{T} (65)

where (I_{b})**is the non-diagonal 3×3 inertia tensor of the body, Λ is a 3×3 matrix whose columns are the corresponding eigenvectors, and diag(I_{b}) is a diagonal 3×3 matrix with the 3×1 vector of principal inertia I_{b}=(Iₓ I_{y} I_{z}) ^{T} on the diagonal. Note that the matrix Λ^{T} defines rotation from the original axes to the principal axes. The eigenvalue decomposition should be realized by a corresponding function from a C/C++ library.

2) Compute the new rotation matrix γ which rotates the absolute coordinate system to the new body-frame (with principal axes):

γ=Λ^{T}γ* (66)

where γ* is the original 3×3 rotation matrix which rotates the absolute coordinate system to the original body-frame. The matrix γ* is available in the FORTRAN MBO(N)D code (after the least squares fitting).

Compute Inertia Coefficients

Compute the body's inertia coefficients by transforming the principal inertia:

$${K}_{x} = \frac{{I}_{y} - {I}_{z}}{{I}_{z} {I}_{y}} , {K}_{y} = \frac{{I}_{z} - {I}_{x}}{{I}_{x} {I}_{z}} , {K}_{z} = \frac{{I}_{x} - {I}_{y}}{{I}_{y} {I}_{x}} \qquad ( 67 )$$

Additional Initialization Operations due to Euler Parameters

Initialize Euler Parameters

This initialization operation is based on the use of the rotation matrix γ rather than on the Euler angles θ. In this case, the operation becomes invariant to the type of Euler angles.

The initialization operation is based on the general-purpose algorithm for computing the Euler parameters from the rotation matrix. Note that this algorithm ensures that the vector of Euler parameters exactly satisfies the constraint |e|=1 (to be maintained automatically by OMBI during the integration).

Additional Initialization Operations due to Momenta

Initialize Translational Momenta for Rigid Bodies

1) Project the vector of translational velocities U* (expressed in the original body-frame) onto the axes of the absolute coordinate system:

V=(γ*)^{T}U* (68)

Note that the 3×1 vector U* and the 3×3 rotation matrix γ* are available in MBO(N)D after least squares fitting.

2) Transform the vector of translational velocities V into the vector of translational momenta pᵥ:

$$( \begin{matrix}{p}_{{v}_{x}} \\ {p}_{{v}_{y}} \\ {p}_{{v}_{z}}\end{matrix} ) = ( \begin{matrix}{m}_{b} {V}_{x} \\ {m}_{b} {V}_{y} \\ {m}_{b} {V}_{z}\end{matrix} ) \qquad ( 69 )$$

where Vₓ, V_{y}, and V_{z} are projections of the vector of translational velocities V onto the axes of the absolute coordinate system, and m_{b} is the mass of the body.

Initialize Rotational Momenta for Rigid Bodies

1) Project the vector of angular velocities ω* (expressed in the original body-frame) onto the axes of the new body-frame (with principal axes):

ω=Λ^{T}ω* (70)

where the rotation 3×3 matrix Λ^{T} is computed via the eigenvalue decomposition and physically formalizes rotation from the original body-frame to the new body-frame (with principal axes).

2) Transform the vector of angular velocities ω into the vector of rotational momenta p_{ω}:

$$( \begin{matrix}{p}_{{ω}_{x}} \\ {p}_{{ω}_{y}} \\ {p}_{{ω}_{z}}\end{matrix} ) = ( \begin{matrix}{I}_{x} {ω}_{x} \\ {I}_{y} {ω}_{y} \\ {I}_{z} {ω}_{z}\end{matrix} ) \qquad ( 71 )$$

where ωₓ, ω_{y}, and ω_{z} are projections of the vector of angular velocities ω onto the axes of the new body-frame, and Iₓ, I_{y}, I_{z} are the principal inertia.

The OMBI algorithm for particles and bodies is described separately for particles and bodies in order to highlight similarity of some operations and difference of other operations for particles and rigid bodies. The design of the OMBI module in C++ should combine these operations when it is possible.

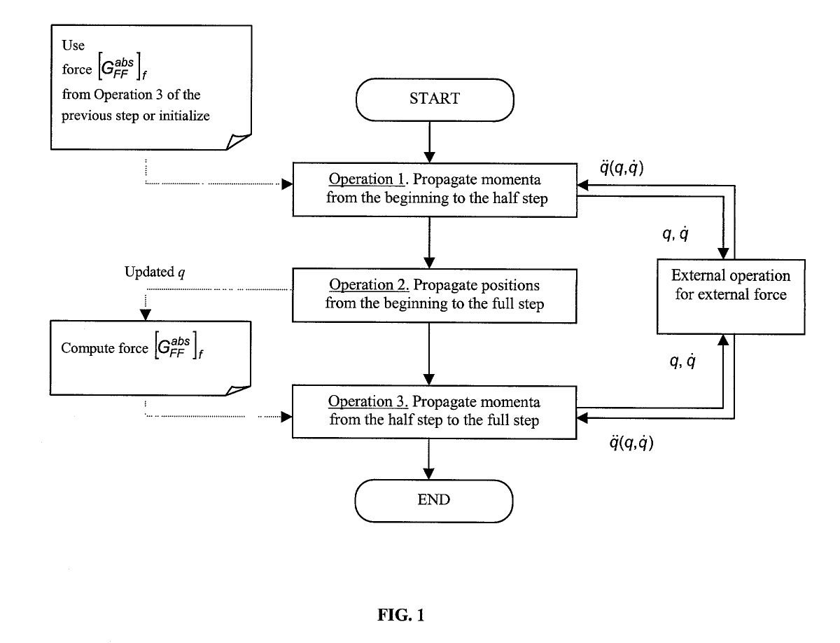

The OMBI algorithm for particles is nothing else than a Verlet-type integrator or a second-order Runge-Kutta-Nystrom integrator. However, as was mentioned above, the OMBI algorithm for particles is described via a formalism of the OMBI algorithm for rigid bodies due to desired universality. The OMBI algorithm for particles can be formalized in the block-flow diagram shown in FIG. 1.

Operation 1: Propagate Momenta from the Beginning of the Time Step to the Half Step

This operation includes propagating the 3×1 vector of translational momenta, pᵥ. It is organized via a function Pᵥ{•}. Note that introduction of this momenta propagation function is convenient for its reuse at Operation 3 of this OMBI for particles. Also, this function can be used for propagating the translational momenta of the body's COM in the OMBI for rigid bodies. Moreover, this function can be used in the next OMBI versions (e.g. in the Stage 3 OMBI for flexible bodies).

Compute Input for Function Pᵥ{•}

The input for function Pᵥ{•} includes a position-dependent vector └G_{FF}^{abs}┘_{f} which is the 3×1 translational force (the forcefield component of the generalized force) expressed in the absolute coordinate system.

The integration process should be organized in such a way that makes it possible to use (at Operation 1 of OMBI) the position-dependent external force └G_{FF}^{abs}┘_{f} computed at Operation 3 of the previous time step.

Reusing the external force └G_{FF}^{abs}┘_{f} is especially important due to the fact that evaluation of this force is very expensive in MD applications.

However, for the very first step of integration the external force └G_{FF}^{abs}┘_{f} should be computed from initialization (as shown in Operation 3 of OMBI).

Propagate Translational Momenta via Function Pᵥ{•}

The vector of translational momenta is propagated from the beginning of the time step to the half step by using the following function

$${p}_{{v}_{1 / 2}} = {P}_{v} \{ \frac{Δ t}{2} , {p}_{{v}_{0}} \} \qquad ( 72 )$$

In Eq. (72), Pᵥ{•} is a function defined as follows

pᵥ(tₛ+τ)=Pᵥ{τ,pᵥ(tₛ)} (73)

The following variables are the inputs for Eq. (73):

τ is the interval of propagation,

pᵥ(tₛ) is the 3×1 vector of translational momenta at the start point tₛ,

[G_{FF}^{abs}]_{f} is the 3×1 translational block (force) of the forcefield component of the generalized force in the absolute coordinate system (the first block in the vector G_{FF}^{abs}).

In Eq. (73) the output is the following:

pᵥ(tₛ+τ) is the 3×1 vector of translational momenta at the finish point tₛ+τ.

Correspondingly, for Operation 1 the inputs are

$$τ = \frac{Δ t}{2} , {p}_{v} ( {t}_{s} ) = {p}_{{v}_{0}} ,$$

and the output is pᵥ(tₛ+τ)=pᵥ_{_{½}}(where tₛ=0).

The function Pᵥ{•} is computed as follows.

Propagate translational momenta in a vector form:

pᵥ(tₛ+τ)=pᵥ(tₛ)+[G_{FF}^{abs} ]_{f}τ (74)

Operation 2: Propagate Positions from the Beginning of the Time Step to the Full Step

This operation includes propagating the 3×1 vector of translational positions, r. It is organized via a function Qᵣ{•}. Note that introduction of this position propagation function is convenient for its reuse in the case of OMBI (rigid bodies) for propagating the positions of the body's COM. Moreover, this function can be reused in next OMBI versions (e.g. in the Stage 3 OMBI for flexible bodies).

Propagate Translational Positions via Function Qᵣ{•}

The vector of translational positions is propagated from the beginning of the time step to the full step by using the following function

r₁=Qᵣ{Δt,r₀,pᵥ_{_{½}}} (75)

In Eq. (75), Qᵣ{•} is a function defined as follows

r(tₛ+τ)=Qᵣ{τ,r(tₛ),pᵥ} (76)

The following variables are the inputs for Eq. (76):

τ is the interval of propagation,

r(tₛ) is the 3×1 vector of Cartesian coordinates at the start point tₛ,

pᵥ is the 3×1 vector of translational momenta “frozen” at a particular instant,

m is the mass of the particle (or body).

In Eq. (76) the output is the following:

r(tₛ+τ) is the 3×1 vector of Cartesian coordinates at the finish point tₛ+τ.

Correspondingly, for Operation 2 the inputs are τ=Δt, r(tₛ)=r₀, pᵥ=pᵥ_{_{½}}and the output is r(tₛ+τ)=r₁ (where tₛ=0).

The function Qᵣ{•} is computed via the following sequence of steps.

1) Convert the momentum vector pᵥ into the velocity vector v:

$$v = ( \begin{matrix}{v}_{x} \\ {v}_{y} \\ {v}_{z}\end{matrix} ) = ( \begin{matrix}\frac{{p}_{{v}_{x}}}{m} \\ \frac{{p}_{{v}_{y}}}{m} \\ \frac{{p}_{{v}_{z}}}{m}\end{matrix} ) \qquad ( 77 )$$

2) Propagate the translational positions, r, from the beginning of the time step to the full step:

r(tₛ+τ)=r(tₛ)+vτ (78)

Operation 3: Propagate Momenta from the Half Step to the Full Step

This operation includes propagating the vector of translational momenta, pᵥ. It is organized via a function Pᵥ{•} (associated with Operation 1 of OMBI).

Compute Input for Function Pᵥ{•}

The input for function Pᵥ{•} includes a position-dependent vector └G_{FF}^{abs}┘_{f}.

The integration process should be organized in such a way that at Operation 3 of OMBI the position-dependent vector └G_{FF}^{abs}┘_{f} should be recomputed. This due to the fact that the position vector q was changed at Operation 2 of OMBI.

Compute External Force └G_{FF}^{abs}┘_{f}

The vector └G_{FF}^{abs}┘_{f} of size 3×1 is a forcefield component of the generalized force applied to a particle and expressed in the absolute coordinate system.

The input └G_{FF}^{abs}┘_{f} is position-dependent and for Operation 3 it corresponds to the generalized positions at the end of the integration step: q=q(Δt)=q₁.

Propagate Translational Momenta

The vector of translational momenta is propagated from the half step to the full step by using the function Pᵥ{•} (associated with Operation 1 of OMBI):

$${p}_{{v}_{1}} = {P}_{v} \{ \frac{Δ t}{2} , {p}_{{v}_{1 / 2}} \} \qquad ( 79 )$$

Correspondingly, as shown in Eq. (79) for Operation 3 the inputs to the function Pᵥ{•} are

$$τ = \frac{Δ t}{2} , {p}_{v} ( {t}_{s} ) = {p}_{{v}_{1 / 2}} ,$$

and the output is pᵥ(tₛ+τ)=pᵥ_{₁} (where

$$( where {t}_{s} = \frac{Δ t}{2} ) .$$

).

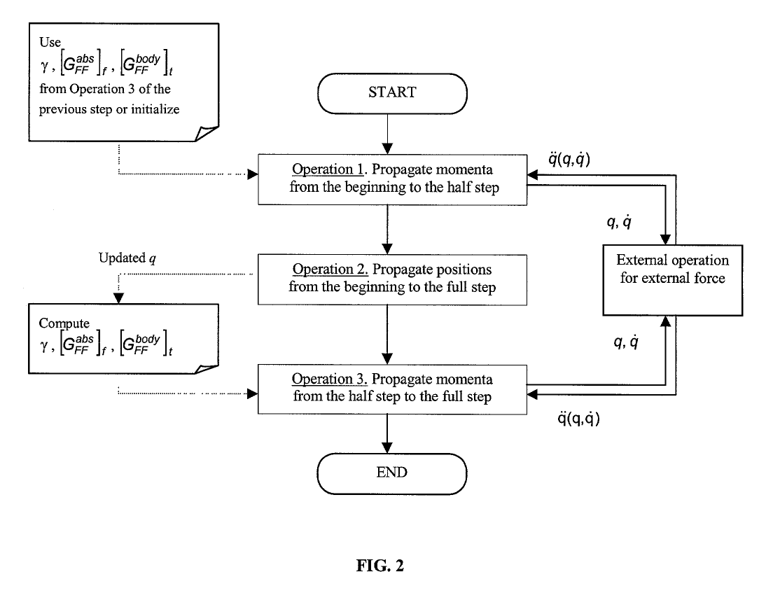

The OMBI algorithm for rigid bodies can be formalized in the following block-flow diagram scheme of FIG. 2. FIG. 2 is similar to FIG. 1 (i.e., OMBI for particles) which is due to the fact that the OMBI for particles is a particular case of the OMBI for rigid bodies. As shown in FIG. 2, the OMBI algorithm for rigid bodies consists of three major operations as follows:

Operation 1: Propagate Momenta from the Beginning of the Time Step to the Half Step

This operation includes propagating both translational pᵥ and rotational p_{ω}momenta. Correspondingly, the former is organized via a function Pᵥ{•} and the latter is organazied via a function P_{ω}{•}. Note that the function Pᵥ{•} can be reused from the OMBI for particles. Also, note that introduction of the rotational momenta propagation function P_{ω}{•} is convenient for its reuse at Operation 3 of this OMBI and in the next OMBI versions (e.g. in the Stage 3 OMBI for flexible bodies).

Compute Inputs for Functions Pᵥ{•} and P_{ω}{•}

The inputs for functions Pᵥ{•} and P_{ω}{•} include one position-dependent matrix and two position-dependent vectors: γ, └G_{FF}^{abs}┘_{f}, and └G_{FF}^{body}┘ₜ.

Correspondingly:

γ is the orthogonal rotation matrix of size 3×3 which rotates the absolute coordinate system to the body-frame,

└G_{FF}^{abs}┘_{f} is the 3×1 translational block (force) of the forcefield component of the generalized force in the absolute coordinate system (the first block in the vector G_{FF}^{abs}),

└G_{FF}^{body}┘ₜ is the 3×1 rotational block (torque) of the forcefield component of the generalized force in the body-frame (the second block in the vector G_{FF}^{body}).

As shown in FIG. 2, the integration process should be organized in such a way that makes it possible to use (at Operation 1 of OMBI) the position-dependent matrices and vectors (γ, └G_{FF}^{abs}┘_{f}, and └G_{FF}^{body}┘ₜ) computed at Operation 3 of the previous time step.

Reusing the external force G_{FF}^{abs} is especially important due to the fact that evaluation of this force is very expensive in MD applications.

However, for the very first step of integration the external force G_{FF}^{abs} and other position-dependent constructions (γ, etc.) should be computed from initialization (as shown in Operation 3 of OMBI).

Propagate Momenta via Functions Pᵥ{•} and P_{ω}{•}

Propagate Translational Momenta via Function Pᵥ{•}

The vector of translational momenta is propagated from the beginning of the time step to the half step by using the following function

$${p}_{{v}_{1 / 2}} = {P}_{v} \{ \frac{Δ t}{2} , {p}_{{v}_{0}} \} \qquad ( 80 )$$

Note that the function Pᵥ{•} can be reused from the OMBI for particles. Correspondingly, as shown in Eq. (80), for Operation 1 the inputs are τ=Δt/2, pᵥ(tₛ)=pᵥ_{₀}, and the output is p(tₛ+τ)=pᵥ_{_{½}}(where tₛ=0).

Propagate Rotational Momenta via Function P_{•{•}}

The vector of rotational momenta is propagated from the beginning of the time step to the half step by using the following function

$${p}_{{ω}_{1 / 2}} = {P}_{ω} \{ \frac{Δ t}{2} , {p}_{{ω}_{0}} \} \qquad ( 81 )$$

In Eq. (81), P_{ω{•} is a function to be used twice in this OMBI (at Operations} 1 and 3). It is defined as follows

p_{ω}(tₛ+τ)=P_{ω}{τ,p_{ω}(tₛ)} (82)

The following variables are the inputs for Eq. (82):

τ is the interval of propagation,

p_{ω}(tₛ) is the 3×1 vector of rotational momenta at the start point tₛ,

K_{b} is the 3×1 vector of the bodys inertia coefficients (Kₓ, K_{y}, K_{z}),

γ is the orthogonal rotation matrix from the absolute coordinate system to the body-frame,

[G_{FF}^{body}]ₜis the 3×1 rotational block (torque) of the forcefield component of the generalized force in the body-frame.

In Eq. (82), the output is the following:

p_{ω}(tₛ+τ) is the 3×1 vector of rotational momenta at the finish point tₛ+τ.

Correspondingly, for Operation 1 the inputs are

$$τ = \frac{Δ t}{2} , {p}_{ω} ( {t}_{s} ) = {p}_{{ω}_{0}} ,$$

and the output is p_{ω}(tₛ+τ)=p_{ω}_{_{½}}(where tₛ=0).

The function P_{ω}{•} is computed as follows.

Propagate rotational momenta in a scalar form based on the Trotter decomposition:

$${p}_{{ω}_{x}} ( {t}_{h} ) = {p}_{{ω}_{x}} ( {t}_{s} ) + \{ {K}_{x} {p}_{{ω}_{y}} ( {t}_{s} ) {p}_{{ω}_{z}} ( {t}_{s} ) + {[ {G}_{FF}^{body} ]}_{{t}_{x}} \} \frac{τ}{2} \\ {p}_{{ω}_{y}} ( {t}_{h} ) = {p}_{{ω}_{y}} ( {t}_{s} ) + \{ {K}_{y} {p}_{{ω}_{z}} ( {t}_{s} ) {p}_{{ω}_{x}} ( {t}_{h} ) + {[ {G}_{FF}^{body} ]}_{{t}_{y}} \} \frac{τ}{2} \\ {p}_{{ω}_{z}} ( {t}_{f} ) = {p}_{{ω}_{z}} ( {t}_{s} ) + \{ {K}_{z} {p}_{{ω}_{x}} ( {t}_{h} ) {p}_{{ω}_{y}} ( {t}_{h} ) + {[ {G}_{FF}^{body} ]}_{{t}_{z}} \} τ \\ {p}_{{ω}_{y}} ( {t}_{f} ) = {p}_{{ω}_{y}} ( {t}_{h} ) + \{ {K}_{y} {p}_{{ω}_{z}} ( {t}_{f} ) {p}_{{ω}_{x}} ( {t}_{h} ) + {[ {G}_{FF}^{body} ]}_{{t}_{y}} \} \frac{τ}{2} \\ {p}_{{ω}_{x}} ( {t}_{f} ) = {p}_{{ω}_{x}} ( {t}_{h} ) + \{ {K}_{x} {p}_{{ω}_{y}} ( {t}_{f} ) {p}_{{ω}_{z}} ( {t}_{f} ) + {[ {G}_{FF}^{body} ]}_{{t}_{x}} \} \frac{τ}{2} \qquad ( 83 )$$

In Eq. (83), the “half”

$$( {t}_{h} = {t}_{s} + \frac{τ}{2} )$$

and “finish” (t_{f}=tₛ+τ) instants are introduced for briefness of notations (the values tₕ and t_{f} do not need to be computed).

Operation 2: Propagate Positions from the Beginning of the Time Step to the Full Step

This operation includes propagating both translational r and rotational e positions. Correspondingly, the former is organized via a function Qᵣ{•} and the latter is organized via a function Qₑ{•}. Note that the function Qᵣ can be reused from the OMBI for particles. Also, note that introduction of the rotational position propagation function Qₑ{•} is convenient for its reuse in the next OMBI versions (e.g. in the Stage 3 OMBI for flexible bodies).

Propagate Positions via Functions Qᵣ{•} and Qₑ{•}

Propagate Translational Positions via Function Qᵣ{•}

The vector of translational positions is propagated from the beginning of the time step to the full step by using the following function

r₁=Qᵣ{Δt,r₀,pᵥ_{_{½}}} (84)

Note that the function Qᵣ{•} can be reused from the OMBI for particles. Correspondingly, as shown in Eq. (84), for Operation 2 the inputs are τ=Δt, r(tₛ)=r₀, pᵥ=pᵥ_{_{½}}and the output is r(tₛ+τ)=r₁ (where tₛ=0).

Propagate Rotational Positions via Function Qₑ{•}

This operation should be organized in a separate reusable function since it can be used in different OMBI algorithms. In the case of OMBI for rigid bodies the operation is used only once.

The rotational positions are represented by the vector of Euler parameters e and are propagated as follows (at the full time step for rigid bodies)

e₁=Qₑ{Δt,e₀,p_{ω}_{_{½}}} (85)

In Eq. (85), Qₑ{•} is a function to be used in different OMBI algorithms. It is defined as follows

e₁=Qₑ{τ,e(tₛ),p_{ω}} (86)

The following variables are the inputs for Eq. (86):

τ is the interval of propagation,

e(tₛ) is the 4×1 vector of Euler parameters at the start point tₛ,

p_{ω} is the 3×1 vector of angular momenta “frozen” at a particular instant.

I_{b} is the 3×1 vector of the body's principal inertia (Iₓ, I_{y}, I_{z}),

In Eq. (86), the output is the following:

e(tₛ+τ) is the 4×1 vector of Euler parameters at the finish point tₛ+τ.

Correspondingly, for Operation 2 the inputs are τ=Δt, e(tₛ)=e₀, p_{ω}=p_{ω}_{_{½}} and the output is e(tₛ+τ)=e₁ (where tₛ=0).

The function Qₑ{•} is computed via the following sequence of steps.

1) Convert the angular momentum vector p_{ω} to the angular velocity vector ω (both expressed in the body-frame):

$$ω = ( \begin{matrix}{ω}_{x} \\ {ω}_{y} \\ {ω}_{z}\end{matrix} ) = ( \begin{matrix}\frac{{p}_{{ω}_{x}}}{{I}_{x}} \\ \frac{{p}_{{ω}_{y}}}{{I}_{y}} \\ \frac{{p}_{{ω}_{z}}}{{I}_{z}}\end{matrix} ) \qquad ( 87 )$$

2) Calculate the magnitude of the angular velocity vector ω:

|ω|=\sqrt{ωₓ²+ω_{y}²+ω_{z}²} (88)

3) Calculate the half of the magnitude |ω|:

$$v = \frac{\vert ω \vert}{2} \qquad ( 89 )$$

4) Precalculate the following sine and cosine:

cᵥ=cos(vτ), sᵥ=sin(vτ) (90)

5) Calculate the normalized angular velocity vector in the body-frame, \overline{ω}:

$$( \begin{matrix}{\overline{ω}}_{x} \\ {\overline{ω}}_{y} \\ {\overline{ω}}_{z}\end{matrix} ) = ( \begin{matrix}\frac{{ω}_{x}}{\vert ω \vert} \\ \frac{{ω}_{y}}{\vert ω \vert} \\ \frac{{ω}_{z}}{\vert ω \vert}\end{matrix} ) \qquad ( 91 )$$

6) Evaluate analytically the matrix exponent Ψ(ω) (note that only the elements in the upper triangular are shown due to symmetry):

$$Ψ ( ω ) = ( \begin{matrix}{c}_{v} & {s}_{v} {\overline{ω}}_{x} & {s}_{v} {\overline{ω}}_{y} & {s}_{v} {\overline{ω}}_{z} \\ & {c}_{v} & {s}_{v} {\overline{ω}}_{z} & {s}_{v} {\overline{ω}}_{y} \\ & & {c}_{v} & {s}_{v} {\overline{ω}}_{x} \\ & & & {c}_{v}\end{matrix} ) \qquad ( 92 )$$

7) Propagate the vector of Euler parameters over the specified interval τ:

e(tₛ+τ)=Ψ(ω)e(ₛ) (93)

Operation 3: Propagate Momenta from the Half Step to the Full Step

This operation includes propagating both translational pᵥ and rotational p_{ω} momenta. Correspondingly, the former is organized via a function Pᵥ{•} and the latter is organized via a function P_{ω}{•} (associated with Operation 1 of OMBI).

Compute Inputs for Functions Pᵥ{•} and P_{ω}{•}

The inputs for functions Pᵥ{•} and P_{ω}{•} include one position-dependent matrix and two position-dependent vectors: γ, └G_{FF}^{abs}┘_{f}, and └G_{FF}^{body}┘ₜ. These matrix and vectors are described for Operation 1 of OMBI.

The integration process should be organized in such a way that at Operation 3 of OMBI the position-dependent matrices and vectors (γ, └G_{FF}^{abs}┘_{f}, and └G_{FF}^{body}┘ₜ) should be recomputed. This due to the fact that the position vector q was changed at Operation 2 of OMBI.

Compute Rotation Matrix γ

The orthogonal rotation matrix γ of size 3×3 rotates the absolute coordinate system to the body-frame. This matrix is needed only for rigid bodies (not particles).

The rotation matrix γ is computed as a function of the four Euler parameters e. Note that for Operation 3 the vector of Euler parameters corresponds to the end of the integration step: e=e(Δt)=e₁. Also note that the vector of Euler parameters e of size 4×1 is the first block in the vector of generalized positions q .

Compute External Force G_{FF}^{abs}

The vector G_{FF}^{abs} of size 6×1 is a forcefield component of the generalized force expressed in the absolute coordinate system. The vector G_{FF}^{abs} includes two blocks: translational force and torque. The translational force, └G_{FF}^{abs}┘_{f}, is a vector of size 3×1 representing the force applied to the body. The torque, └G_{FF}^{abs} ┘ₜ, is the vector of size 3×1 representing the torque applied about the body-frame origin. Both are expressed in the absolute coordinate system.

The input G_{FF}^{abs} is position-dependent and for Operation 3 it corresponds to the generalized positions at the end of the integration step: q=q(Δt)=q₁.

Compute Torque [G_{FF}^{body}]ₜ in Body-Frame

Project the torque vector from the absolute coordinate system to the body-frame:

i [G_{FF}^{body}]ₜ=γ[G_{FF}^{abs}]ₜ (94)

where γ is the rotation matrix.

Propagate Momenta via Functions Pᵥ{•} and P_{ω}{•}

Propagate Translational Momenta via Function Pᵥ{•}

The vector of translational momenta is propagated from the half step to the fall step by using the function Pᵥ{•} (associated with Operation 1 of OMBI):

$${p}_{{v}_{1}} = {P}_{v} \{ \frac{Δ t}{2} , {p}_{{v}_{1 / 2}} \} \qquad ( 95 )$$

Correspondingly, as shown in Eq. (95), for Operation 3 the inputs to the function Pᵥ{•} are

$$τ = \frac{Δ t}{2} ,$$

pᵥ(tₛ)=pᵥ_{_{½}}, and the output is pᵥ(tₛ+τ)=pᵥ_{₁}

(where

$$( where {t}_{s} = \frac{Δ t}{2} ) .$$

Propagate Rotational Momenta via Function P_{ω}{•}

The vector of rotational momenta is propagated from the half step to the full step by using the function P_{ω}{•} (associated with Operation 1 of OMBI):

$${p}_{{ω}_{1}} = {P}_{ω} \{ \frac{Δ t}{2} , {p}_{{ω}_{1 / 2}} \} \qquad ( 96 )$$

Correspondingly, as shown in Eq. (96), for Operation 3 the inputs to the function P_{ω}{•} are

$$τ = \frac{Δ t}{2} ,$$

p_{ω}(tₛ)=p_{ω}_{_{½}}, and the output is p_{ω}(tₛ+τ)=p_{ω}_{₁} (where

$$( where {t}_{s} = \frac{Δ t}{2} ) .$$

).

Implementation of Efficient Constraint-Handling Formulation/Architecture

In the previous Sections the OMBI algorithm was introduced for unconstrained multibody dynamics. In this Section we present the OMBI in a combination with SHAKE formulation to account for the bond-length constraints. It should be noted that this formulation for the constrained multi-body dynamics was chosen during the Phase II work from several candidate methodologies under consideration for treating constrained MBD systems with the OMBI (as described below).

Enforcing constraints is a well-proven technique used in molecular dynamics for atomistic models realized in such algorithms as SHAKE and RATTLE, among others. In the body-based formulation, substructuring of atoms into bodies already means introducing of “hard” (if a body is rigid) or “soft” (if a body is flexible) constraints, and, thus, reducing the high-frequency dynamics. However, enforcing constraints between bodies helps to make further improvements in extracting the essential (low-frequency) dynamics from less interesting high-frequency motions (e.g., bond-stretching motion). The MBO(N)D technology offers an efficient O(N) algorithm for modeling dynamics of a system of connected bodies (Refs. 60, 61). This algorithm is based on the use of relative hinge coordinates and makes it possible to enforce exact constraints on the parameters of interest such as bond lengths, bond angles, and dihedral angles while integrating motion with respect to the remaining “free” coordinates (unconstrained degrees of freedom). Our experience in simulating reduced-variable constrained molecular dynamics by MBO(N)D indicates that enforcing bond length constraints between bodies will usually suffice for the goal of removing high-frequency dynamics. Therefore, the task of incorporating constraints into OMBI is reduced to that of accounting for bond length constraints.

The above simplification (enforcing only bond length constraints), combined with the re-formulation of the multibody dynamics in terms of momenta and Euler parameters, provided a unique opportunity for incorporating constraints. We therefore decided to take a broader look at this problem and to investigate three possible approaches: 1) O[(n+m)]³ SHAKE-type solution (Ref. 51) which is based on Gauss-Seidel iterations and modified by us for body-based formulation, 2) O(n+m) recursive algorithm which is the core algorithm for constrained multibody dynamics in MBO(N)D, and 3) the impetus-striction method which is based on a reformulation of the constrained Lagrangian systems in which constraints are manifested as integrals of motion. With the proven feasibility of the OMBI for unconstrained dynamics in absolute coordinates as well as the fact that all three candidate approaches mentioned above for incorporating constraints are proven concepts which have been in use for a long time, it was clear that the task of generalizing the OMBI to the case of constrained dynamics was a low risk task which, however, helped to significantly enhance the performance of MBO(N)D-II. As was mentioned above, in MBO(N)D-II we accounted for the constraints via the OMBI in a combination with SHAKE formulation.

In Phase II Proposal for this research work, three possible approaches for constrained multibody dynamics were proposed, namely: 1) SHAKE-like algorithm for body-based formulation, 2) O(n+m) recursive algorithm, and 3) Impetus-striction method. During the Phase II work we investigated all these three approaches and decided to implement in the OO C++ code only the first (SHAKE-like) approach. Correspondingly, we finalized the development and carried out implementation of the combined OMBI/SHAKE algorithm, which accounts for the bond-length constraints between bodies and particles.

Another alternative in the development of the OMBI for constrained molecular dynamics is the incorporation of the O(n+m) recursive algorithm used in the current version of MBO(N)D (but, with the Euler angles parametrization). The O(n+m) recursive algorithm offers a more elegant way of solving a system of constrained equations than SHAKE-like iterations for tree topologies. The advantage of this solution is that no SHAKE-like iterations are required since the Lagrange multipliers are explicitly eliminated from the equations of motion due to the use of relative (hinge) coordinates. The current O(n+m) algorithm in MBO(N)D consists of three recursive sweeps through the system topology—a first forward recursion to obtain the absolute velocities from the relative velocities, a backward recursion to compute equivalent inertias and forces, and a second forward recursion to evaluate the relative accelerations. For closed-loop topologies, a hinge is arbitrarily selected for treatment as a cut-joint, whereby the local topology becomes a tree if all constraints are removed from the cut-joint hinge. Upon selection of appropriate cut-joints, the system can then be treated as a topological tree, subject to constraint forces that are present at the cut-joints. Additional recursive calculations are done to explicitly solve for the cut-joint Lagrange multipliers that enforce those constraints.

No major changes are needed in the O(n+m) algorithm itself for incorporation into OMBI. The minor changes that are needed involve new kinematics in the form of Euler parameters instead of Euler angles, and new dynamics terms in the form of momenta instead of velocities. Since the O(n+m) algorithm is the most efficient for tree topologies, it makes sense to only apply the SHAKE-like iterations for the constraints related to closed-loop topologies, where Lagrange multipliers are calculated enforcing constraints at the cut joints. Since there is usually a small number of closed-loops in most biological molecules (and substructuring makes this number even smaller), the system that the iterative solution is applied to will be of low dimension, while most of the hinge constraints between bodies (associated with the topological tree portions of the model, and hence treated with the O(n+m) algorithm) will be eliminated explicitly.

The fact that we needed to treat the closed-loops through the SHAKE-type algorithm, finally lead us to the conclusion that open-loop constraints should be also treated through the SHAKE-type algorithm. The hybrid SHAKE/O(N) formulation would have introduced unnecessary complexity in the OO C++ MBO(N)D-II code. At the same time, the universal treatment of the open- and closed-loop topologies in molecular systems allowed for a more efficient treatment of large-scale MD simulations with a bulk of explicit water molecules (modeled via unconstrained multi-body dynamics which were integrated via the OMBI described in herein.

A novel approach to constrained MD, referred to as the Impetus-Striction method, involves a new mathematical formulation of holonomically constrained systems. It has been shown that infinite dimensional (i.e., PDE) constrained Lagrangian dynamical systems can effectively be written as unconstrained Hamiltonian systems in which the constraints are, by construction, integrals of the motion. These ideas have already proven useful in various macroscopic examples of classical continuum mechanics. In the finite dimensional (i.e., ODE) context of constrained MD the new technique is a simple variant of Kozlov's “vakonomic” mechanics. However, even in the ODE context the numerical ramifications of the new formulation do not appear to have been explored. In particular we continue to investigate whether the new Hamiltonian systems will yield more efficient schemes for MD simulations. For example in MD with quadratic bond length (and angle) constraints the differential algebraic problem of integrating constrained second-order time dynamics can be recast as the conservative integration of Hamiltonian dynamics with quadratic integrals.

The idea of the impetus-striction formulation is as follows. Many systems can naturally be formulated as Lagrangian systems that are subject to constraints. The bond length and angle constraints in molecular dynamics are certainly of this type, as are the multibody constraints that arise in MBO(N)D. Consideration of the dynamics of inextensible and unshearable rods (Refs. 19-23) led to a novel unconstrained Hamiltonian formulation of a rather general class of such Lagrangian systems. The desired constraint is by construction a first integral of the Hamiltonian dynamics. However the Hamiltonian, H(x,y) say, is only defined after an auxiliary minimization

$$H ( x , y ) = {min}_{λ} \tilde{H} ( x , y , λ ) \qquad ( 97 )$$

where we call tilde H(x,y,λ) the pre-Hamiltonian. Here y is the conjugate variable to the configuration variable x, but in applications y is typically not the classic momentum or impulse, and so we give it a new name, the impetus. In applications the quantity λ is generally the time anti-derivative of a familiar physical quantity, e.g., for incompressible fluid flow λₜ is the pressure field. λ can also be interpreted as a Lagrange multiplier enforcing a time-differentiated constraint, but to distinguish it from the usual multiplier, we call λ the striction.

The new formulation holds great promise in the context of multibody molecular dynamics. Moreover, due to fact that the implementation of the impetus-striction method to the quadratic (bond length) constraints is straightforward, we considered this task as a low-risk task. The main effort is undertaken in order to merge the impetus-striction methodology of handling constraints with the explicit integrator for multibody dynamics, namely the OMBI. It should be mentioned that at this point in time, the impetus-striction method is used with the implicit symplectic Runge-Kutta discretizations since they automatically conserve quadratic integrals. However, in MD the use of implicit integrators is prohibitive due to large computational cost of forcefield evaluations.

The fact that it was practically impossible to implement the impetus-striction formalism in a form of the explicit integrator, lead us to the decision to abandon this approach and finalize the MBO(N)D-II developments with the SHAKE-type constrained formulation. The practical difficulty in implementing the impetus-striction formalism consisted in the fact that we discovered that the implicit integrator was needed to ensure the stable integration process of the constrained multi-body dynamics under conditions that the constraints are maintained only at the velocity level. A combination of the explicit integrator and the treatment of the constraints at the velocity level appeared to be insufficient for the stable integration. Correspondingly, we concluded that a combination of the explicit integrator (OMBI) with the SHAKE-type formalism (which treats constraints at the position level) is a more powerful approach to the constrained multi-body MD.

The SHAKE-like approach offers a very simple and straightforward way of enforcing bond-length constraints, which has been proven to be a way of retaining the symplectic property of the Verlet-type integrator for dynamical systems with velocity-independent terms. The main idea consists in the iterative Gauss-Seidel-Newton (GSN) solution of a system of nonlinear equations which represent discrepancies between the bond lengths to be maintained and the bond lengths predicted at the end of the integration step. The GSN iterations may include a successive overrelaxation (SOR) scheme to increase the speed of convergence. In the nonlinear equations that arise, the prediction of the momentum and position vector within the integration step are performed in the same way as in the Verlet-type integrator, but with additional constraint forces characterized by Lagrange multipliers.

The OMBI developed on the basis of the Liouville-Trotter formalism is a generalization of the Verlet-type integrator in the sense that the Liouville-Trotter decomposition does not provide the final finite-difference equation to propagate the momentum or position states but only decomposes the system of differential equations into a system of simpler differential equations. In order to propagate momentum or position states within the integration step, one has to solve a system of differential equations. We developed analytical solutions of the systems of differential equations arising as a result of the Liouville-Trotter decomposition of equations of multibody dynamics for the formulation with Euler parameters and momenta. These results can be extended to the case of constrained dynamics and the formalism of the SHAKE method can be directly used for generalizing OMBI to the case of constrained dynamics. Moreover, since OMBI demonstrates conservation properties which indicate that it is most likely a symplectic integrator (we plan to prove this mathematically), the SHAKE-type iterations will not degrade those properties, i.e., it is expected that the OMBI for constrained dynamics will retain its high performance in terms of conserving the total energy and momenta in the conservative system. It should also be mentioned that the SHAKE-like approach has such advantageous properties as handling both open- and closed-loop topologies of the linked bodies, and is very amenable for parallelization.

In atomistic molecular dynamics, the classical combination of the Verlet integrator and SHAKE algorithm is a well-proven technique to increase the integration step (by 2-4 times) by removing rapid vibrational modes associated with the bonds. The combination of a SHAKE-like approach with the body-based OMBI algorithm is a direct generalization of the above classical results to the case when a molecule is substructured into a set of flexible bodies and particles. It will become clear below that this generalization is not trivial.

The formulation of multibody dynamics in terms of Euler parameters was described for unconstrained bodies was described hereinbefore. This formulation made it possible to simplify the integrator's derivations by considering each body in the system individually. This is not the case for interconnected bodies. While deriving the OMBI for the case of constrained dynamics, we will use the following notation. The multibody dynamics (yet to be constrained) will be described exactly in the form of Eq. (5) (for a single body):

\dot{q}=V(q,p)

\dot{p}=G(q,p) (98)

But the state-vector q and the momentum vector p will have the block-vector structure:

$$q = ( \begin{matrix}\underline{{q}_{1}} \\ ⋮ \\ \overline{{q}_{N}}\end{matrix} ) , p = ( \begin{matrix}\underline{{p}_{1}} \\ ⋮ \\ \overline{{p}_{N}}\end{matrix} ) \qquad ( 99 )$$

where each i-th block corresponds to the i-th body in the system of N bodies. Moreover, we will assume that the system may include both flexible bodies and particles. In the case when the i-th block corresponds to a flexible body, the position vector for the body includes 3 sub-blocks: e—the 4×1 vector of Euler parameters, x—the 3×1 vector of translational coordinates of the body's center of mass (COM), and ξ—the vector mᵢ×1 of modal coordinates (see Eq. (7)). The momentum vector for each body also includes 3 sub-blocks: p_{ω}−(3×1), pᵤ−(3×1), and p_{ξ}−(mᵢ×1). The momentum vector is introduced as a linear combination of the corresponding velocity vector (see Eq. (9)) which includes the 3×1 block ω of the body's angular velocities projected onto the body frame, the the 3×1 block u of the translational velocities of the body's COM projected onto the body frame, and the mᵢ×1 block of the modal velocities. A general form of the mass matrix for each flexible body is introduced in Eq. (10). Note that the case of a rigid body is a particular case of a flexible body if one excludes the ξ-blocks from the corresponding position and momentum vectors as well as from the mass matrix. Similarly, in the case when the i-th block in the system corresponds to a particle, the position vector for the body includes only 3 translational coordinates x, and the momentum vector includes only 3 elements expressed through translational velocities u (projected on to absolute axes). In this case the mass matrix is a 3×3 diagonal matrix with the particle's mass on the diagonal.

Let us introduce bond-length constraints into the multibody dynamics, i.e. assume that the bodies in the system are interconnected by means of bonds. Normally, two bodies are connected by only one bond, which links two specified atoms on both bodies. However, the molecular structure may consist of both open- or closed-loop topologies. We assume that there are L bond-length constraints in the system which can be formalized by one vector equation

g(q)=0 (100)

Note that Eq. (100) falls into the class of holonomic (position) constraints. Also, note that the constraint is expressed in the most general form as a function of the full state-vector q. But, only the i-th and j-th blocks of the state-vector q are directly involved in forming a bond-length constraint between i-th and j-th bodies in the system:

g(qᵢ,qⱼ)=0 (101)

This determines the structure of the sparsity in the corresponding matrix constructions that will arise in the process of deriving the equations for constrained multibody dynamics. In a more detailed form each l-th constraint may be expressed as

[Xᵢₖ(qᵢ)−Xⱼᵣ(qⱼ)]²+[Yᵢₖ(qᵢ)−Yⱼᵣ(qⱼ)]²+[Zᵢₖ(qᵢ)−Zⱼᵣ(qⱼ)]²−b_{I}²=0 (102)

where the triple {X, Y, Z} stands for the absolute Cartesian coordinates of the atom participating in the bond-length constraint. The index i or j denotes the body's number in the system, while the index k or r denotes the atom's index within the body. Further specification of the form of Eq. (102) detailization depends on whether the atom participating in the bond is an individual particle or belongs to a rigid or flexible body.

In the case of a particle, its three Cartesian coordinates coincide with the corresponding block of the state-vector:

$$( \begin{matrix}{X}_{i} \\ {Y}_{i} \\ {Z}_{i}\end{matrix} ) = {q}_{i} ( k = 1 ) \qquad ( 103 )$$

In the case of a body, the 3 Cartesian coordinates of the k-th atom in the i-th body are defined by the following transformational equation:

$$( \begin{matrix}{X}_{ik} \\ {Y}_{ik} \\ {Z}_{ik}\end{matrix} ) = {( \begin{matrix}{X}_{i} \\ {Y}_{i} \\ {Z}_{i}\end{matrix} )}_{COM} + C ( {e}_{i} ) ( \begin{matrix}Δ {X}_{ik} \\ Δ {Y}_{ik} \\ Δ {Z}_{ik}\end{matrix} ) \qquad ( 104 )$$

where the first term in the right-hand side represents the absolute position of the COM for the i-th body and the second term represents relative coordinates (marked with Δ) of the k-th atom in the body frame rotated in absolute space according to the rotation matrix C(eᵢ). Note that the matrix C(eᵢ) depends quadratically on the four Euler parameters (see Eq. (15)). In the general case of a flexible body, the vector of relative coordinates for the k-th atom in the body frame depends on the modal states which model deformational motion:

$$( \begin{matrix}Δ {X}_{ik} \\ Δ {Y}_{ik} \\ Δ {Z}_{ik}\end{matrix} ) = {( \begin{matrix}Δ {X}_{ik} \\ Δ {Y}_{ik} \\ Δ {Z}_{ik}\end{matrix} )}_{0} + Φ ( \begin{matrix}\underline{{ξ}_{1}} \\ ⋮ \\ \overline{{ξ}_{{m}_{i}}}\end{matrix} ) \qquad ( 105 )$$

Here the index “0” corresponds to the non-deformed state of the body, and the (3×mᵢ) matrix Φ is a matrix of the corresponding mode shapes which project the current modal states into the current relative coordinates of the k-th atom in the body frame. Note that the case of rigid body entails that ξ≡0.

Eqs. (102)-(105) applied to each bond constitute a general nonlinear vector constraint of Eq. (100). The structure of this vector constraint is defined by the connectivities in the system and by the type of body (particle, rigid body, flexible body). It should be emphasized that the above model of bond-length constraints for a set of flexible bodies has a convenient analytical representation which involves only polynomial nonlinearities. This is achieved through the use of an Euler parameter formulation for the description of the rotational motion of bodies. The convenient (polynomial) form of the constraint equations is a crucial factor in merging the OMBI with the SHAKE-type algorithm for constrained dynamics.

According to a variational principle, the equations of motion (98) subject to L holonomic constraints (100) may be written in the form:

\dot{q}=V(q,p)

\dot{p}=G(q,p)+[g′(q)]^{T}λ

0=g(q) (106)

where λ is a (L×1) vector of time-dependent Lagrange multipliers (constraint forces) and g′(q) is (L×n) Jacobian matrix for the vector constraint of Eq. (100):

$${g}^{′} ( q ) = \frac{\partial }{\partial q} g ( q ) \qquad ( 107 )$$

Note that the Jacobian matrix is very sparse due to the aforementioned topology of connectivities. Indeed, only two bodies are connected by a bond. Moreover, for protein molecules, for example, the topological structure is mostly open (tree topology) with a few possible closed loops. Substructuring molecules into bodies tends to eliminate most of the closed loops (such as rings) by including them within a single (rigid or flexible) body. Eq. (106) forms a system of differential-algebraic equations (DAEs) of index three; three differentiations are required in order to reduce the equations to a system of ordinary differential equations. The solution manifold underlying Eqs. (106), and (107) is M={(q, p)|g(q)=0, g′(q)DM⁻¹p=0}. Note that here the “hidden” constraint g′(q)DM⁻¹p=0 is obtained through time differentiation of the position constraint and is nothing more than the original bond-length constraint at the velocity level.

While deriving the OMBI for unconstrained multibody dynamics it was emphasized that the Liouville-Trotter formalism leads to an efficient time-symmetric decomposition of the original system of differential equations into a set of simpler systems of differential equations. This principally differs from the case of atomistic molecular dynamics where the Liouville-Trotter formalism directly yields a time-symmetric discretization of the system of differential equations in the form of the Verlet integrator (RESPA-type approach). Correspondingly, the art of designing the OMBI consisted in solving the decomposed equations while taking full advantage of their analytical properties. The same approach will be implemented for constrained dynamics in order to derive the OMBI/SHAKE algorithm.

Using the Liouville-Trotter formalism, we decomposed the system of Eq. (106) into five subsystems of differential equations. In the case of constrained dynamics, the solutions of those subsystems are coupled by the need to satisfy additional algebraic conditions, namely g(q)=0 and g′(q)DM⁻¹p=0 (i.e., to satisfy the bond-length constraints at on the position and velocity levels).

The decomposed equations of constrained motion include five stages presented below as a generalization of the five-stage OMBI for unconstrained dynamics herein.

Stage 1. Propagate the momentum vector to the half step t=Δt/2 freezing the position states and the vector of Lagrange multipliers at t=0:

$$\dot{p} = G ( {q}_{0} , p ) + {( [ {g}^{′} ( {q}_{0} ) ] )}^{T} {λ}_{0} , t ∈ ( 0 , \frac{Δ t}{2} ) \qquad ( 108 )$$

with initial conditions p(0)=p₀. Note that unlike the case of unconstrained multibody dynamics (see Eq. (21)), now the “semi-frozen” equation for momenta is no longer a closed expression for p_{½}since one has to evaluate the vector of Lagrange multipliers λ₀ from the condition of satisfying the bond-length constraints on the position level:

g(q₁)=0 (109)

where vector q₁ is the state-vector of the system at the end of the time step t=Δt and is available only after the next 3 stages are realized.

Stage 2. Propagate the vector of rigid position variables to the half step t=Δt/2 freezing the flexible position variables at t=0 and the momentum vector at t=Δt/2:

$$\dot{z} = {V}_{z} ( z , {ξ}_{0} , {p}_{1 / 2} ( {λ}_{0} ) ) , t ∈ ( 0 , \frac{Δ t}{2} ) \qquad ( 110 )$$

with initial conditions z(0)=z₀. Note that unlike the case of unconstrained multibody dynamics (see Eq. (22)), the operation of Eq. (110) depends on the undetermined vector of the Lagrange multipliers λ₀.

Stage 3. Propagate the vector of flexible position variables to the full step t=Δt using momenta (recomputed in modal velocities) at t=Δt/2:

\dot{ξ}=U_{ξ}_{_{½}}(λ₀), tε(0,Δt) (111)

with initial conditions ξ (0)=ξ₀. Note that the dependency of the operation of Eq. (111) on the vector of Lagrange multipliers λ₀ is due to the fact that the vector of absolute velocities is a result of solving a system of linear equations (Eq. (9)) (at t=Δt/2) where the corresponding momentum vector p_{½}depends on λ₀ (see Stage 1).

Stage 4. Propagate the vector of rigid position variables to the full step t=Δt freezing the flexible position variables at t=Δt and the momentum vector at t=Δt/2:

$$\dot{z} = {V}_{z} ( z , {ξ}_{1} , {p}_{1 / 2} ( {λ}_{0} ) ) , t ∈ ( \frac{Δ t}{2} , Δ t ) \qquad ( 112 )$$

with initial conditions

$$z ( \frac{Δ t}{2} ) = {z}_{1 / 2} .$$

Note that this operation unlike its “unconstrained” counterpart (see Eq. (24)) depends on the undetermined vector of Lagrange multipliers λ₀. It is important to stress that Eq. (109) along with Eqs. (108), and (1 10)-(1 12), define a system of nonlinear equations to be solved with respect to the vector of Lagrange multipliers λ₀.

Stage 5. Propagate the momentum vector to the fall step t=Δt freezing the position states and the vector of Lagrange multipliers at t=Δt:

$$\dot{p} = G ( {q}_{1} , p ) + {( [ {g}^{′} ( {q}_{1} ) ] )}^{T} {λ}_{1} , t ∈ ( \frac{Δ t}{2} , Δ t ) \qquad ( 113 )$$

with initial conditions

$$p ( \frac{Δ t}{2} ) = {p}_{1 / 2} .$$

Note that unlike the case of unconstrained multibody dynamics (see Eq. (25)), now one has to evaluate the vector of Lagrange multipliers λ₁ from the condition of satisfying the bond-length constraints at the velocity level:

g′(q₁)D(q₁)M(q₁)⁻¹p₁(λ₁)=0 (114)

In other words, one has to solve a L-dimensional system of nonlinear equations for λ₁ defined by Eq. (114) along with Eq. (113).

Note that dealing with the bond-length constraint on the velocity level entails that we actually use the RATTLE (enhanced) version of the SHAKE-type algorithm. However, we will use the name SHAKE as it is common in the literature on integrators. For atomistic MD, according to Ref. 3, the “pure” SHAKE and SHAKE/RATTLE algorithms are both global second order accurate (assuming that the nonlinear equations are solved exactly at each step). The two methods are equivalent at mesh points if initialized appropriately and, moreover, the SHAKE/RATTLE method provides symplectic discretization of the equations of motion (“pure” SHAKE is also symplectic in a slightly weakened sense (see Ref. 3)).

The further concretization of the OMBI/SHAKE algorithm depends on the method of solving a system of nonlinear equations, which arise due to the Lagrange multiplier formalism. Both the system of Eqs. (109), (108), (110)-(112) Stages 1-4 of the OMBI due to the constraints at the position level) and the system of Eqs. (114) and (113) Stage 5 of the OMBI due to the constraints at the velocity level) may be formalized as a system of nonlinear equations

f(λ)=0 (115)

Since the algorithm for solving this system is to be implemented at each integration step, it should be sufficiently fast in order to make the computational overhead associated with enforcing the constraints much smaller than the reduction in the total CPU time resulting from a longer integration step. This goal can be met thanks to the fact that we need to correct only a small deviation in the bond-length constraints that took place during a single integration step (it is assumed that the constraints were maintained at the previous integration steps.

A first consideration is a classical SHAKE iteration based on the recursive coordinate resetting to satisfy the bond-length constraints one by one. It may be demonstrated that the SHAKE iteration is nothing more than an ordinary Gauss-Seidel-Newton (GSN) method to solve a system of L nonlinear equations by decomposing the latter into L scalar problems. Third, using a general formalism of the GSN method, another possibility is a modification of the SHAKE algorithm based on Successive Over Relaxation (SOR). Finally, a “direct” Newton-Raphson method may be considered for solving a system of nonlinear equations in matrix form while taking full advantage of the sparsity in the Jacobian matrix.

The Symmetric Newton-Raphson Iteration (SNIP) has been considered as an alternative to the conventional Newton-Raphson Iteration (NIP). Motivation for this method comes from the fact that the symmetric approximation of the Jacobian matrix is nearly constant over the coarse of the numerical integration, and hence rarely requires update and refactorization. The SHAKE-type iteration with SOR has been considered to be the most efficient algorithm to maintain bond-length constraints during the integration process. For example, it is up to 3 times faster than the most “exact” NIP iteration or is about 1.5 faster than SNIP (assuming the same level of tolerance in maintaining constraints in all cases). In other words, the SHAKE-type (or to be more general, GSN-type) scalar decomposition of the system of nonlinear equations turns out to be an efficient technique for local corrections of the bond-length constraints at each integration step.

We will utilize the SHAKE-type iteration with SOR in the OMBI/SHAKE algorithm for constrained multibody dynamics. The SHAKE iteration proceeds as follows: We begin by initializing λ=0. Each step of the outer iteration consists of cycling through the L constraints, approximately satisfying each constraint. It is customary to denote by λₗ^{k} the approximation to λ computed at the k-th step of the outer iteration and the l-th stage of the inner iteration (corresponding to each l-th bond). At the k-th step of the outer iteration, the l-th constraint is linearized about λₗ₋₁^{k}, the most recent approximation to λ. The approximation is then corrected in the direction of the gradient in order to satisfy the l-th constraint. In other words, following the more general formalism of the GSN method, one has to solve a scalar nonlinear equation

fₗ(λₗ^{k}. . . λₗ₋₁^{k},λₗ^{k},λₗ₊₁^{k-1}. . . λₗ^{k-1})=0 (116)

for λₗ^{k} at each k-th outer iteration and each l-th inner stage. This solution may be formalized in the form

$${λ}_{l}^{k} [ i + 1 ] = {λ}_{l}^{k - 1} - μ \frac{{f}_{l} ( {λ}_{l}^{k} [ i ] )}{{f}_{l}^{′} ( {λ}_{l}^{k} [ i ] )} \qquad ( 117 )$$

where the index i denotes internal iterations to solve the scalar nonlinear equation, and μ is the relaxation parameter which can usually hasten convergence. One wishes to find a μ which is optimal for rapid convergence of the iterative process. This is the essence of Successive OverRelaxation (SOR).

In implementing the OMBI/SHAKE algorithm for constrained multibody dynamics we plan to utilize the adaptive relaxation algorithm. It is based on the observation that in the process of MD one has to repeatedly solve nonlinear systems whose form does not change from step to step (we assume that this observation made for atomistic MD will also hold for substructured MD). Thus one can use the behavior of iteration during the early stages of the integration to find a good value of the relaxation parameter μ via iterative improvement. The adaptive relaxation algorithm may be formulated as follows:

Initialize:

μ₀=1

γ₀=0

Δ=Δ₀

FOR k=0,1, . . . (time steps)

integrate and perform SHAKE/SOR with relaxation parameters μₖ

compute average convergence factor γₖ (see text below)

IF γₖ>γₖ₋₁

$$Δ = - \frac{Δ}{2}$$

END IF

μₖ₊₁=μₖ+Δ

END FOR

Note that in the above algorithm Δ₀ is a parameter, one recommended value of which Δ₀=0.1). Also, the convergence factor γ might be taken as the number of iterations required for convergence or as the ratio of iterates

$$\frac{Δ {λ}_{l}^{k + 1}}{{Δλ}_{l}^{k}} .$$

In concluding this Section, we would like to mention that substructuring the molecule into a set of bodies significantly reduces the total number of bond-length constraints in the system (compared to an atomistic representation). This will result in a more efficient SHAKE-type algorithm due to a shorter recursive sweep over the constraints (i.e. due to a smaller number of scalar nonlinear equations to solve).

These results provide the principal framework for the OMBI/SHAKE algorithm. In order to have the final algorithm for coding, one has to provide the analytical expressions for Eqs. (109), (108), (110)-(112) needed to numerically integrate the sub-systems of differential-algebraic equations at all five stages of the OMBI integrator. Equations (109), (108), (110)-(112) parametrically depend on the vectors of Lagrange multipliers λ₀ and λ₁. To obtain one has to evaluate all the derivatives involved in the formalism of constrained multibody dynamics. This includes the evaluation of the Jacobian matrix in Eqs. (109), (114) and (113), as well as the derivative of the constraint nonlinearity with respect to the Lagrange multiplier in the SHAKE-type iteration of Eq. (117).

It should be noted that the SHAKE algorithm based on the scalar decomposition of the vector constraint, significantly simplifies the operations mentioned above. Indeed, since the SHAKE algorithm works on each constraint separately, it involves at any step only those blocks in the total state-vector, which correspond, to the two bonded bodies in the system. This differs from the Newton-Raphson iteration, which would require working with all blocks of the state-vector at each step, forming rather complex matrix constructions. The SHAKE-type iteration is up to 3 times more efficient than the NIP iteration implemented even with sparse-matrix optimization. This conclusion was made for atomistic MD. It is quite realistic to assume that in the case of SMD the difference in the CPU time between the SHAKE and NIP iterations would be much larger due to the more complex matrix operations in the case of multibody dynamics. SHAKE-type scalar decomposition helps to reduce the size of the “matrix” constructs. One of the challenges for Phase II will be to prove in practice that the simplification of the Newton iteration to the SHAKE-type (Gauss-Seidel-Newton) iteration in the case of multibody dynamics still fits within the paradigm of “slight” corrections of the bond-length constraints on each integration step (as it does for atomistic MD).

The final concretization of the OMBI/SHAKE algorithm mainly involves routine procedures like taking derivatives. Taking into account the routine character of the final derivations of the OMBI/SHAKE algorithm we will consider only the principal guidelines for those derivations in this Section. During Phase II we will document the final OMBI/SHAKE algorithm in separate technical notes and will implement it in FORTRAN for MBO(N)D. The main principle in evaluating all the necessary derivatives for the OMBI/SHAKE algorithm consists in using a chain rule. This is possible due to the fact that the dependency of the “output” on the “input” is formalized by a sequence of embedded functions and there are analytical expressions for those functions at each level.

Analytical derivation of the Jacobian matrix g′(q) is rather straightforward and involves two-level differentiation of the bond-length nonlinearity defined by Eq. (102). For convenience of notations we will formalize the two-level embedding of nonlinear functions as follows:

g(q)=G(x)

x=X(q) (118)

Here, q is the state-vector of the multibody system (see Eq. (99)). The function G(•) represents the dependency of the bond-length constraints on the absolute Cartesian coordinates x of the two atoms making the bond (see Eq. (102)). The function X(•) formalizes the mapping of the state-vector q into the vector x. Note that the mapping operation depends on the type of body each atom belongs to (particle, rigid body, or flexible body). The corresponding nonlinear relations are defined by Eqs. (103)-(105).

Taking all the above into account, the chain rule yields the following result:

$${g}^{′} ( q ) = \frac{\partial G}{\partial x} \frac{\partial X}{\partial q} \qquad ( 119 )$$

According to Eq. (102), evaluation of the matrix

$$\frac{\partial G}{\partial x}$$

involves differentiation of the quadratic function. According to Eqs. (103)-(105), evaluation of the matrix

$$\frac{\partial X}{\partial q}$$

also involves differentiation of polynomial vector functions with maximal order of 3. Note that the latter is true since we use Euler parameters for body orientation descriptions. Indeed, the rotational matrix C(β) in Eq. (104) is a quadratic function of the corresponding Euler parameters β (which make up one of the blocks in the state vector q). In the case of flexible bodies this quadratic function is “coupled” with the modal amplitudes ξ (which make up another block in the state vector q). This “coupling” yields the polynomial function of the 3^{rd}order which is still easy to differentiate. It should be mentioned that, while forming matrices and performing matrix multiplication in Eq. (119), one should take advantage of the matrix sparsity (which results from the fact that each bond connects only two bodies).

Analytical evaluation of the scalar derivative fₗ′(λₗ^{k}[i]) in the SHAKE iteration of Eq. (117) also involves a chain differentiation. Consider the corresponding formalism only for the case when the function f represents the bond-length constraint at the position level. In this case f stands for g(λ₀) (see Eq. (109) which “couples” stages 1-4 of the OMBI). The second case when f represents the bond-length constraint at the velocity level (see Eq. (114) that arises in g stage 5 of the OMBI) is, in principle, similar to the first case and will be omitted here.

In the considered case, the embedding of nonlinear functions is the following

$$\begin{matrix}g ( {λ}_{0} ) = G ( {x}_{1} ) \\ {x}_{1} = {X}_{1} ( {z}_{1} , {ξ}_{1} ) \\ {z}_{1} = {Z}_{1} ( {z}_{1 / 2} , {ξ}_{1} , {p}_{1 / 2} ) \\ {ξ}_{1} = {Ξ}_{1} ( {p}_{1 / 2} ) \\ {z}_{1 / 2} = {Z}_{1 / 2} ( {p}_{1 / 2} ) \\ {p}_{1 / 2} = {P}_{1 / 2} ( {λ}_{0} )\end{matrix} \qquad ( 120 )$$

It should be noted that due to scalar decomposition of the SHAKE iteration one has to work only with a single element of the vectors and λ₀ while evaluating the derivative g′(λ₀). The latter significantly simplifies implementation of the chain rule for the sequence (120) since it is sufficient to deal only with those blocks of the related vectors x, z, ξ, and p that correspond to the two bodies making the current bond. Note that in Eq. (120) the indexes 0, ½, and 1 denote the beginning, the middle, and the end of the time step. The nonlinear functions for all six levels in Eq. (120) are described elsewhere herein. The 6^{th} level in Eq. (120) formalizes the propagation of the momentum vector p at the first half step (see Eq. (108), Stage 1 of the OMBI). The 5^{th} level formalizes the propagation of the rigid states z at the first half step (see Eq. (110), Stage 2 of the OMBI). The 4^{th} level formalizes the propagation of the flexible states ξ at the full step (see Eq. (111), Stage 3 of the OMBI). The 3^{rd} level formalizes the propagation of the rigid states z at the second half step (see Eq. (113), Stage 4 of the OMBI). The 2^{nd} level formalizes the transformation of the body's rigid and flexible states into the absolute Cartesian coordinates of the atoms making the bond (see Eqs. (1 03)-(105)). The 1^{st} level formalizes the bond-length constraint as a function of the absolute Cartesian coordinates of the atoms (see Eq. (102)).

Given the above nonlinearities, one can implement the following chain rule:

$$\begin{matrix}{g}^{′} ( {λ}_{0} ) = \frac{\partial G}{\partial {x}_{1}} \frac{\partial {X}_{1}}{\partial {λ}_{0}} \\ \frac{\partial {X}_{1}}{\partial {λ}_{0}} = \frac{\partial {X}_{1}}{\partial {z}_{1}} \frac{\partial {Z}_{1}}{\partial {λ}_{0}} + \frac{\partial {X}_{1}}{\partial {ξ}_{1}} \frac{\partial {Ξ}_{1}}{\partial {λ}_{0}} \\ \frac{\partial {Z}_{1}}{\partial {λ}_{0}} = \frac{\partial {Z}_{1}}{\partial {z}_{1 / 2}} \frac{\partial {Z}_{1 / 2}}{\partial {λ}_{0}} + \frac{\partial {Z}_{1}}{\partial {ξ}_{1}} \frac{\partial {Ξ}_{1}}{\partial {λ}_{0}} + \frac{\partial {Z}_{1}}{\partial {p}_{1 / 2}} \frac{\partial {P}_{1 / 2}}{\partial {λ}_{0}} & ( 121 ) \\ \frac{\partial {Ξ}_{1}}{\partial {λ}_{0}} = \frac{\partial {Ξ}_{1}}{\partial {p}_{1 / 2}} \frac{\partial {P}_{1 / 2}}{\partial {λ}_{0}} \\ \frac{\partial {Z}_{1 / 2}}{\partial {λ}_{0}} = \frac{\partial {Z}_{1 / 2}}{\partial {p}_{1 / 2}} \frac{\partial {P}_{1 / 2}}{\partial {λ}_{0}} & ( 112 )\end{matrix}$$

It should be noted that all nonlinear functions in Eq. (121) are expressed in closed form that is amenable for analytical differentiation. Those functions are rather simple for the 1^{st} and 2^{nd} levels (polynomial functions up to the 3rd order). But even the functions at the 3^{rd} to 6^{th} levels have elegant analytical expressions. In the practical implementation of Eq. (121) one has to account for scarcity in all matrix operations. The sparsity comes both from the fact that only the coordinates related to two bodies are involved for each bond as well as from the fact that the translational, rotational, and deformational (due to structural flexibility) matrix constructions are uncoupled to some extent in multibody dynamics.

The important functionality needed for implementation of the constrained multi-body dynamics, is initialization of those dynamics. The latter entails that the bond-length constrains between bodies (both at the position and velocity levels) should be satisfied at the beginning of the MD simulations (t=0).

It is important to stress that from a mathematical point of view the problem of initialization is very similar to the problem of maintaining the constraints during integration via the OMBI/SHAKE algorithm. We took advantage of this similarity by designing reusable classes in C++. Below these C++ classes are described from an algorithmical point of view.

The VelocityFitter class is designed to interpret both the atomistic system and the substructured system (which is contained in a DynamicSystem object). The purpose of this class is to find the best fit of body velocities that will reproduce as close as possible the atomic velocities, while maintaining any bond-length velocity constraints and maintaining the exact system momenta as in the original atomistic system.

Variable List

N_{Va}^{b}=Number of atom velocities associated with a particular body, b=3N_{A}^{b}

N_{A}^{b}=Number of atoms in body b

N_{X}^{b}=Number of velocities in body b,=3 translational for particle, 6 (trans+ang) for rigid body

N_{A}=Total number of atoms in system

N_{X}=Total number of body velocities in system

N_{VA}=Total number of atom velocities in system=3N_{A}

A^{b}=Matrix that takes body b velocities and transforms into the bodies specific atom velocities

A=Block diagonal matrix that takes the set of all body velocities and transforms into the set of all atom velocities.

V_{A}^{b}=atom velocity vector for all atoms in body b, of dimension 3N_{VA}^{b}×1

C^{b}=Transformation matrix for body b that transforms inertial coordinates into body-based coordinates

sᵢ^{b}=internal, body-frame relative coordinates of atom i in body b

N_{B}=Total number of bodies (entities=particles and rigid bodies) in system

X_{b}=The body velocity vector={v_{b} ω_{b}}^{T} for rigid bodies

X=The set of all body velocity vectors

Determining the body velocity vector that best reproduces the inertial atomic velocities of the atoms in a body start with the equations for computing the atom velocities from body velocities. We show the equations for a rigid body only, since the transformation for a particle is one-to-one, i.e., the atom velocity for a particle IS the body velocity. For an atom i in body b, the velocity of the atom is the sum of the body velocity (inertial frame translational velocity) and the cross-product of the body angular velocity with the atom relative position, projected into the inertial frame,

$$\begin{matrix}{V}_{Ai}^{b} = {v}_{b} + {( [ {C}^{b} ] )}^{T} {ω}_{b} \times {s}_{i}^{b} \\ = {v}_{b} - {( [ {C}^{b} ] )}^{T} {s}_{i}^{b} \times {ω}_{b} \\ = {v}_{b} - {( [ {C}^{b} ] )}^{T} [ {\tilde{s}}_{i}^{b} ] {ω}_{b}\end{matrix} \qquad ( 122 )$$

which can be written in the form of a matrix operator acting on the rigid body velocity vector X_{b} as,

$${V}_{A i}^{b} = [ \begin{matrix}1 & 0 & 0 \\ 0 & 1 & 0 \\ 0 & 0 & 1\end{matrix} [ - {C}^{{b}^{T}} {\tilde{s}}_{i}^{b} ] ] {X}_{b} = {A}_{i}^{b} {X}_{b} \qquad ( 123 )$$

The matrix A^{b} transforming all atoms in the body to atomic velocities in the inertial frame is given by:

$${A}^{b} = [ \begin{matrix}{A}_{1}^{b} \\ {A}_{2}^{b} \\ ⋮ \\ {A}_{{N}_{A}^{b}}^{b}\end{matrix} ]$$

such that the velocities of all atoms in body b is

$${V}_{A}^{b} = \{ \begin{matrix}{V}_{A1}^{b} \\ {V}_{A2}^{b} \\ ⋮ \\ {V}_{{A}_{N}}^{b}\end{matrix} \} = {A}^{b} {X}_{b}$$

Then, the entire set of atom velocities can be found from the entire set of body velocities by the matrix transformation A, which is a block diagonal matrix of all A^{b} body matrices,

$$A = [ \begin{matrix}{A}^{1} & & & 0 \\ & {A}^{2} & & \\ & & ⋰ & \\ 0 & & & {A}^{{N}_{B}}\end{matrix} ] \\ and \\ {V}_{A} = {\{ \begin{matrix}{V}_{A}^{1} \\ {V}_{A}^{2} \\ ⋮ \\ {V}_{A}^{{N}_{a}}\end{matrix} \}}_{{N}_{V A} \times 1} = {A}_{{N}_{V A} \times {N}_{x}} {X}_{{N}_{x} \times 1} \qquad ( 124 )$$

First consider the unconstrained case. In this case, we are simply looking at the problem of solving for n unknowns from m equations, where m>n. This is a minimization problem:

Solve

AX=V_{A}

to minimize the cost function of the error, e=V_{A}−AX,

$$J ( X ) = \frac{1}{2} {e}^{T} e = \frac{1}{2} {( {V}_{A} - A X )}^{T} ( {V}_{A} - A X ) \qquad ( 125 )$$

which can be solved by setting

$$\frac{\partial J}{\partial X} = 0 = - {A}^{T} {V}_{A} + {A}^{T} A X \qquad ( 126 )$$

which yields the solution for X using the pseudo inverse of A,

X=[A^{T}A]⁻¹A^{T}V_{A}=A^{t}V_{A} (127)

For large systems, there is no problem of inverting large matrices, for due to the structure of A, being block diagonal by body, the solution for X can be solved body by body for X_{b},

X_{b}=[A^{b}^{^{T}}A^{b}]⁻¹A^{b}^{^{T}}V_{A}^{b} (128)

Now generalize the results to the constrained case. Here, we wish to solve the problem: Solve for X the following system of equations

AX=V_{A}

to minimize the cost function of the error, e=V_{A}−AX,

$$J ( X ) = \frac{1}{2} {e}^{T} e = \frac{1}{2} {( {V}_{A} - A X )}^{T} ( {V}_{A} - A X ) \qquad ( 129 )$$

subject to the constraints,

φ(X)=0

As with the unconstrained case, we come to the equation:

A^{T}AX=A^{T}V_{A} (130)

which is very similar in form to the dynamics equation: M\ddot{q}=F. We can view the matrix A^{T}A as a pseudo-mass matrix for the system. To satisfy the constraints, we add Lagrange Multipliers, λ, and use the Jacobian matrix of the Constraints,

$$D = \frac{\partial φ}{\partial X} = [ \frac{\partial {φ}_{i}}{\partial {X}_{j}} ]$$

to solve the following system of equations,

$$\begin{matrix}{A}^{T} A X & + & {D}^{T} λ & = & {A}^{T} {V}_{A} \\ D X & & & = & 0\end{matrix} , \qquad ( 131 )$$

or in matrix form,

$$[ \begin{matrix}{A}^{T} A & {D}^{T} \\ D & 0\end{matrix} ] \{ \begin{matrix}X \\ λ\end{matrix} \} = \{ \begin{matrix}{A}^{T} {V}_{A} \\ 0\end{matrix} \} \qquad ( 132 )$$

In actuality, there are two sets of constraints, one for bond-length velocities and one for system momenta, and the above problem can be further subdivided into φ_{V} for bond-length constraints and φ_{Z} for momenta constraints. Similarly, we can subdivide the Lagrange multipliers into λ_{V} and λ_{Z}, which yields

$$[ \begin{matrix}{A}^{T} A & {D}_{V}^{T} & {D}_{Z}^{T} \\ {D}_{V} & 0 & 0 \\ {D}_{Z} & 0 & 0\end{matrix} ] \{ \begin{matrix}X \\ {λ}_{V} \\ {λ}_{Z}\end{matrix} \} = \{ \begin{matrix}{A}^{T} {V}_{A} \\ 0 \\ 0\end{matrix} \} \qquad ( 133 )$$

We will discuss the solution method for the Lagrange multipliers later. For now, let us assume that we have values for the bond-length and momenta Lagrange multipliers. Then, we are simply solving a modified least-squares equation for X,

$${A}^{T} A X = {A}^{T} {V}_{A} - {D}_{V}^{T} {λ}_{V} - {D}_{Z}^{T} {λ}_{Z} \\ X = {[ {A}^{T} A ]}^{- 1} \{ {A}^{T} {V}_{A} - {D}_{V}^{T} {λ}_{V} - {D}_{Z}^{T} {λ}_{Z} \} \qquad ( 134 )$$

Again, the solution of large systems is made simpler by the fact that the above problem can be solved for body by body (once Lagrange Multipliers have been solved), because we can look at the body-by-body contributions of the products of the Jacobians and Lagrange multipliers. This will become evident when we look more closely at computing the Jacobians and their data structures.

The bond-length constraint between an atom on body A and an atom on body B is formed by the statement that the distance computed by the sum of the squares of the differences in atom positions minus the bond-length distance squared must be zero,

$$φ = Δ {x}^{2} + Δ {y}^{2} + Δ {z}^{2} - {d}^{2} = 0 \\ Δ x = {x}_{A} - {x}_{B} ; Δ y = {y}_{A} - {y}_{B} ; Δ z = {z}_{A} - {z}_{B} \qquad ( 135 )$$

The velocity constraint is the time derivative of the above equation,

$$\dot{φ} = 2 Δ x Δ \dot{x} + 2 Δ y Δ \dot{y} + 2 Δ z Δ \dot{z} = 0 \\ Δ \dot{x} = {\dot{x}}_{A} - {\dot{x}}_{B} ; Δ \dot{y} = {\dot{y}}_{A} - {\dot{y}}_{B} ; Δ \dot{z} = {\dot{z}}_{A} - {\dot{z}}_{B} \qquad ( 136 )$$

The equation development of this Section is somewhat figurative in describing the constraints and constraint Jacobian. For Bond-length constraints, the constraints as functions of the body-velocities are actual the time-derivative of the bond-length constraints (which are functions of the body generalized coordinates). If we denote the vector of body generalized coordinates as q and the vector of body generalized velocities as \dot{q}, then the variables we are solving for are actually X=\dot{q}. Now, the partial derivate of the constraint vector with respect to the generalized coordinates for particles is a relatively simple thing (since the coordinates of the particle are the coordinates of the atom in question). We will look at the case for rigid bodies, which have Quaternions to represent the orientation, yielding 7 generalized coordinates per body. However, the generalized velocities using body-frame angular velocities for orientation rates, and thus there are only 6 generalized velocities for rigid bodies. Therefore, in order to compute the constraint Jacobian for rigid bodies, we use the relationship,

$$\dot{φ} = \frac{\partial }{\partial t} φ ( q ) = \frac{\partial φ}{\partial q} \frac{\partial q}{\partial t} = [ \frac{\partial φ}{\partial q} ] \dot{q} \\ \frac{\partial \dot{φ}}{\partial \dot{q}} = \frac{\partial }{\partial \dot{q}} ( [ \frac{\partial φ}{\partial q} ] \dot{q} ) = [ \frac{\partial φ}{\partial q} ] \qquad ( 137 )$$

Using the above equation, if we let φᵥ=\dot{φ}, then δφ/δq=δ\dot{φ}/δ\dot{q}=δφᵥ/δX.

If there are NB_{Bond} length constraints, then φᵥ will be a vector of N_{Bond} equations, each equation connecting two entities. Now, the Jacobian for the entire system, Dᵥ=δφᵥ/δX, can be analyzed by looking at, for each constraint, the two bodies the constraint connects. All other body blocks will be zero (partials w.r.t. body variables that are not in the equation are zero). Each body block of the constraint Jacobian will be either 1×3 or 1×6 depending on whether the body is a particle or rigid body, respectively. We can look at an example structure of a constraint Jacobian,

$${D}_{v} = \begin{matrix} & {B}_{1} & {B}_{2} & {B}_{3} & {B}_{4} & … & {B}_{{N}_{B}} \\ {φ}_{1} & {[ \frac{\partial {φ}_{1}}{\partial {X}_{B1}} ]}_{1 \times {N}_{X}^{1}} & {[ \frac{\partial {φ}_{1}}{\partial {X}_{B2}} ]}_{1 \times {N}_{X}^{2}} & & & & \\ {φ}_{2} & & {[ \frac{\partial {φ}_{2}}{\partial {X}_{B2}} ]}_{1 \times {N}_{X}^{2}} & {[ \frac{\partial {φ}_{2}}{\partial {X}_{B3}} ]}_{1 \times {N}_{X}^{3}} & & & \\ {φ}_{3} & & & {[ \frac{\partial {φ}_{3}}{\partial {X}_{B3}} ]}_{1 \times {N}_{X}^{3}} & {[ \frac{\partial {φ}_{3}}{\partial {X}_{B4}} ]}_{1 \times {N}_{X}^{4}} & & \\ ⋮ & & & & & & \\ {φ}_{N c} & & & {[ \frac{\partial {φ}_{N c}}{\partial {X}_{B3}} ]}_{1 \times {N}_{X}^{3}} & & & {[ \frac{\partial {φ}_{N c}}{\partial {X}_{B N B}} ]}_{1 \times {N}_{X}^{{N}_{B}}}\end{matrix} \qquad ( 138 )$$

The structure of the Jacobian in equation (138) provides insight into how to handle the sparsity of the Jacobian for large systems. We will discuss this further in the section on methods and attributes of the VelocityFitter class.

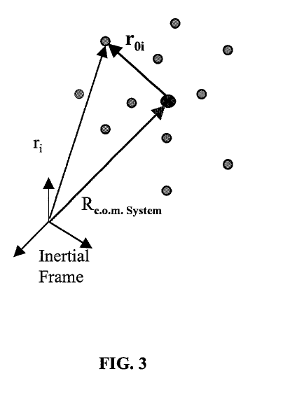

The purpose of the momentum constraints is to ensure that the resulting fit for body velocities produces the same system momenta as computed from the atomistic system. First, we will discuss the equations for computing system Linear and Angular Momenta from both atom-based and body-based systems, graphically shown in FIG. 3.

For the atom based system, we can find the instantaneous system center of mass from the coordinates and masses of the atoms,

$${r}_{S y s t e m c . o . m .} = \frac{\sum {r}_{i} {m}_{i}}{\sum {m}_{i}} \qquad ( 139 )$$

and we can calculate the vector from the system center of mass to the i-th atom by

r_{Sys c.o.m.}+rₒᵢ=rᵢ

rₒᵢ=rᵢ−r_{Sys c.o.m.} (140)

For the following discussion, we define G₀, H₀ as the System Linear and Angular momenta vectors, and Z₀={G₀^{T} H₀^{T}}^{T}. We will denote the quantities computed from the atomistic system by the subscript α and the quantities computed from the body-based system by the subscript β.

For the atomistic system, the Linear momentum vector is found by the equation,

$${( {G}_{0} )}_{a} = {\sum }_{allatoms} {m}_{i} {v}_{i} \qquad ( 141 )$$

and the Angular momentum vector is found from summing the contributions to angular momentum from all atoms in the system about the system center of mass,

$$\begin{matrix}{( {H}_{0} )}_{α} = {\sum }_{all atoms} {m}_{i} {r}_{0 i} \times {v}_{i} \\ = {\sum }_{all atoms} {m}_{i} [ {\tilde{r}}_{0 i} ] {v}_{i}\end{matrix} \qquad ( 142 )$$

System Momentum Using Atomic Velocities Computed from Body Velocities

In this case, we attempt to make the System Momentum calculations as close as possible to the original atomic-velocity calculations. We compute the atomic velocities from the bodies' velocities. For each body, we use Eq. (123) to map body velocities into its constituent atom velocities, A_{b}X_{b}=V_{A}^{b}. Then, to compute the System Linear momentum, we can use the matrix formulation,

$$\begin{matrix}{G}_{0 β} = {\sum }_{Bodies} \underbrace{[ [ {m}_{1} {1}_{3 \times 3} ] [ {m}_{2} {1}_{3 \times 3} ] ⋯ [ {m}_{{N}_{c}^{b}} {1}_{3 \times 3} ] ]}_{3 \times 3 {N}_{c}^{b}} \underbrace{{A}_{b}}_{3 {N}_{c}^{b} \times {N}_{x}^{b}} \underbrace{{X}_{b}}_{{N}_{x}^{b} \times 1} & ( 143 ) \\ {H}_{0 β} = {\sum }_{Bodies} \underbrace{[ [ {m}_{1} {\tilde{r}}_{{0}_{1}} ] [ {m}_{2} {\tilde{r}}_{{0}_{2}} ] ⋯ [ {m}_{{N}_{c}^{b}} {\tilde{r}}_{{0}_{Nc}} ] ]}_{3 \times 3 {N}_{c}^{b}} \underbrace{{A}_{b}}_{3 {N}_{c}^{b} \times {N}_{x}^{b}} \underbrace{{X}_{b}}_{{N}_{x}^{b} \times 1} & ( 144 )\end{matrix}$$

such that the Body-velocity computed System momentum vector can be represented as

$${Z}_{0 β} = {\sum }_{Bodies} \underbrace{[ \begin{matrix}[ {m}_{1} {1}_{3 \times 3} ] & [ {m}_{2} {1}_{3 \times 3} ] & ⋯ & [ {m}_{{N}_{c}^{b}} {1}_{3 \times 3} ] \\ [ {m}_{1} {\tilde{r}}_{{0}_{1}} ] & [ {m}_{2} {\tilde{r}}_{{0}_{2}} ] & ⋯ & [ {m}_{{N}_{c}^{b}} {\tilde{r}}_{{0}_{Nc}} ]\end{matrix} ]}_{6 \times 3 {N}_{c}^{b}} \underbrace{{A}_{b}}_{3 {N}_{c}^{b} \times {N}_{x}^{b}} \underbrace{{X}_{b}}_{{N}_{c}^{b} \times 1} \qquad ( 145 )$$

Then, the body blocks of the Momentum Constraint Jacobian are computed from the 6×3N_{c}^{b} matrix of Eq. (145). For particles, the mapping matrix A_{b} is simply the identity, and the Jacobian body block is found from

$${D}_{z}^{b} = [ \begin{matrix}[ {m}_{1} {1}_{3 \times 3} ] \\ [ {m}_{1} {\tilde{r}}_{{0}_{1}} ]\end{matrix} ] \qquad ( 146 )$$

For rigid bodies, the Jacobian body block for Momentum constraints is computed as

$${D}_{z}^{b} = \underbrace{[ \begin{matrix}[ {m}_{1}^{b} {1}_{3 \times 3} ] & [ {m}_{2}^{b} {1}_{3 \times 3} ] & ⋯ & [ {m}_{{N}_{c}^{b}}^{b} {1}_{3 \times 3} ] \\ [ {m}_{1}^{b} {\tilde{r}}_{{0}_{1}} ] & [ {m}_{2}^{b} {\tilde{r}}_{{0}_{2}} ] & ⋯ & [ {m}_{{N}_{c}^{b}}^{b} {\tilde{r}}_{{0}_{Nc}} ]\end{matrix} ]}_{6 \times 3 {N}_{c}^{b}} \underbrace{{A}_{b}}_{3 {N}_{c}^{b} \times {N}_{x}^{b}} \qquad ( 147 )$$

Using this method to compute system Momentum from the Body-based velocities has the most success at reproducing the closest approximations to the original atomic-based system. We provide the equations for computing the System momentum strictly from body coordinates, velocities and internal body momenta simply for traceability.

System Momentum Using Body-Variables

For the body-based system, the linear momentum is found similarly to the atomistic system,

$${( {G}_{0} )}_{β} = {\sum }_{all Bodies} {m}_{b} {v}_{b} \qquad ( 148 )$$

and the angular momentum is found similarly to the atomistic system, but with any rigid-body's internal angular momentum included as well,

$$\begin{matrix}{( {H}_{0} )}_{β} = {\sum }_{all entities} ( {m}_{b} [ {\tilde{r}}_{0 b} ] {v}_{b} + [ {I}_{b} ] {ω}_{b} ) \\ = {\sum }_{all entities} [ {m}_{b} [ {\tilde{r}}_{0 b} ] {v}_{b} [ {I}_{b} ] {ω}_{b} ] \{ {X}_{b} \}\end{matrix} \qquad ( 149 )$$

Note that in the above equation, if the entity is a particle, then the entity itself has no angular momentum (no rotational inertia).

The momentum constraint is formulated as

φ_{Z}=Z_{β}−Z_{α} (150)

where φ_{Z}, is a 6×1 vector of equations that are all functions of all entities in the system. While the number of constraints is always fixed at 6 (opposed to the system-dependent case of bond-length constraints), the Constraint Jacobian will not be sparse. This is because every body's coordinates are involved in the constraint equations.

From the above equations, we can see that computing the body-blocks of the Momentum constraint Jacobian is rather straightforward. For particles, we have

$${( {D}_{z} )}_{b} = [ \begin{matrix}{m}_{b} [ {1}_{3 \times 3} ] \\ {m}_{b} [ {\tilde{r}}_{0 b} ]\end{matrix} ] \qquad ( 151 )$$

and for rigid bodies we have

$${( {D}_{z} )}_{b} = [ \begin{matrix}{m}_{b} [ {1}_{3 \times 3} ] & 0 \\ {m}_{b} [ {\tilde{r}}_{0 b} ] & [ diag ( {I}_{1} , {I}_{2} , {I}_{3} ) ]\end{matrix} ] \qquad ( 152 )$$

To avoid the inversion of possible very large matrices in a “brute-force” solution method in solving for the Lagrange multipliers, we apply an iterative solution similar to the SHAKE algorithm. Here, we start with λᵥ and λ_{Z} equal to zero vectors,

λᵥ⁽⁰⁾=0; λ_{Z}⁽⁰⁾=0 (153)

We then solve equation (134) for the body velocities, X_{b}, body-by-body, applying the body-blocks of the constraint Jacobians to incorporate contributions of Lagrange Multipliers,

X_{b}^{(iter)}(λ_{V}^{(iter)},λ_{Z}^{(iter)})=[A^{b}^{^{T}}A^{b}]⁻¹{A^{b}^{^{T}}V_{A}^{b}−D_{V}^{b}^{^{T}}λ_{V}^{(iter)}−D_{Z}^{b}^{^{T}}λ_{Z}^{(iter)}} (154)

After the body velocities have been solved from Eq. (154), the constraint violations are computed (i.e., we use Eqs. (136) and (150) to compute φᵥ and φ_{Z}).

$${φ}_{v} = {φ}_{v} ( {X}^{( iter )} ) \\ {φ}_{Z} = {φ}_{Z} ( {X}^{( iter )} ) \qquad ( 155 )$$

We then update the Lagrange Multipliers using a gradient method. For the velocity constraints, we evaluate the increment in Lagrange Multiplier constraint-by-constraint, where c=1, . . . Nc,

$$Δ {λ}_{{V}_{c}} = \frac{{φ}_{{V}_{c}}}{\begin{matrix}{{D}_{{V}_{c}}^{( B1 )} [ {A}^{{B1}^{T}} {A}^{B1} ]}^{- 1} {D}_{{V}_{c}}^{{( B1 )}^{T}} + \\ {{D}_{{V}_{c}}^{( B2 )} [ {A}^{{B2}^{T}} {A}^{B2} ]}^{- 1} {D}_{{V}_{c}}^{{( B2 )}^{T}}\end{matrix}} \qquad ( 156 )$$

Note that the denominator in Eq. (156) is a computationally simplified expansion of the full matrix expression for the denominator, D_{V}_{_{c}}[A^{T}A]⁻¹D_{V}_{_{c}}^{T}. We use the fact that the product A^{T}A is block diagonal by body, the inverse can be computed block by block and that the constraint Jacobian row for the c-th constraint is only non-zero for the two bodies, B1 and B2, that the constraint connects.

For the Momentum constraints, it is easier to compute the increment in Lagrange Multipliers all at once, for there are always only 6 constraints, and Δλ_{Z} will be a 6×1 vector,

$$Δ {λ}_{Z} = {\underbrace{[ \underbrace{{D}_{z}}_{6 \times {N}_{x}} \underbrace{{[ {A}^{T} A ]}^{- 1}}_{{N}_{x} \times {N}_{x}} \underbrace{{D}_{z}}_{{N}_{x} \times 6} ]}_{6 \times 6}}^{- 1} \underbrace{{φ}_{Z}}_{6 \times 1} \qquad ( 157 )$$

Again, the block diagonal structure of the matrix A of Eq. (124) allows us to simplify the computations of the matrix product D_{Z}[A^{T}A]⁻¹D_{Z}^{T} and its inverse, so that at most we are only inverting 6×6 matrices.

Once the Lagrange multiplier increments are computed, we can update the Lagrange multipliers using the formula,

$${λ}_{V}^{( iter + 1 )} = {λ}_{V}^{( iter )} + {α}^{( iter )} {Γ}_{V} Δ {λ}_{V} \\ {λ}_{Z}^{( iter + 1 )} = {λ}_{Z}^{( iter )} + {α}^{( iter )} {Γ}_{Z} Δ {λ}_{Z} \qquad ( 158 )$$

where α is a relaxation parameter that gradually introduces the increment, starting at 0 when iter=0 and increasing to 1, and Γ is an adaptive gain that is either halved or doubled depending on the rate of convergence of the constraints to zero. A good value for the Γ's to begin with is 0.5. During the iterative process, if ∥φ_{V}^{(iter+1)}∥>∥φ_{V}^{(iter)}∥ then we multiply Γ_{V} by 0.5. If in the process of iteration, ∥φ_{V}^{(iter)}∥−∥φ_{V}^{(iter+1)}∥<tolerance, we increase Γ_{V} by a factor of 2. The same procedure is performed for Γ_{Z}. This method has produced the most consistent convergence rates so far.

Relation of OMBI and OMBI/SHAKE to Known Symplectic Integrators

The Optimized Multibody Integrator (OMBI) is derived by using the RESPA-type framework of Ref. 45, which in its turn takes its roots in the general and well-known symmetrization methods for integrating the systems of differential equations. Armed with this general methodology, one has to apply it to the particular structure of differential equations. The OMBI is a result of this application, which utilizes the benefits of the Euler parameter formulation for multibody dynamics and is the first (to the extent of our knowledge) integrator, which is directly tailored to the Euler parameter formulation.

At the same time, in recent years there have been a number of publications on symplectic integrators for rigid body dynamics. It is interesting to compare the OMBI to these integrators. Note that in the following we will not consider the issue of constraints between bodies since the OMBI can incorporate constraints in a way similar to the symplectic integrators that implement a SHAKE-type solution, or utilizing the MBO(N)D's O(N)-algorithm. First, it should be mentioned that the OMBI is a more general integrator since it is implemented for the case of flexible bodies. As a result of this, we also use a more general (non-diagonal) mass matrix which formalizes the couplings between rotational, translational, and deformational motions. One of the most important differences between the OMBI and the symplectic rigid-body integrators integrators that implement a SHAKE-type solution consists in the fact that the OMBI, as was mentioned above, effectively utilizes the benefits of the Euler parameter formulation. In “Symplectic Integrators for Systems of Rigid Bodies”, Reich S., Preprint (1995) (hereinafter “Reich”), the rotational motion is described by the 3×3 rotational matrix Q (which is a state variable with the corresponding conjugate momenta matrix P). In this case, as shown in Reich, the Hamiltonian is separatable, which automatically leads to a symplectic Verlet-type integrator. Although this integrator is simple in notation, its inconvenience consists in the fact that one has to satisfy an additional constraint Q^{T} Q−I=0. The authors of Reich showed that by using the reduced vector of angular momenta p_{ω} (in body frame) instead of the conjugate momenta matrix P, it is possible to obtain equivalent differential equations for p_{ω} and Q (instead of equations for P and Q ) and avoid the need for the constraint Q^{T} Q−I0. But, one still needs to propagate the whole matrix Q (note that the propagator is based on additional Trotter decompositions and evaluation of the corresponding matrix exponentials at each stage of the propagator). The OMBI, on the other hand, simply reduces the propagator for the redundant matrix Q to the equivalent propagator for the Euler parameters e. This propagator does not involve additional Trotter decompositions (the Euler parameters are propagated in the vector form) and, besides, we found a very simple analytical form for the corresponding matrix exponential.

The Phase II Final report, included as Appendix A, provides additional details regarding the present invention.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method of simulating multibody dynamics of a molecular system so as to produce output data representative of a time evolution of the molecular system, comprising:
providing a set of equations for characterizing multibody dynamics of the molecular system, the set of equations being constrained by a constraining equation;
providing an integrator for integrating the set of equations, wherein the integrator is tailored for the set of equations so as to satisfy the constraining equation; and,
applying the integrator to the set of equations over a time step, so as to produce output data representative of the time evolution of the molecular system relative to the time step.

2. A method according to claim 1, further including applying the integrator to the set of equations over a predetermined number of time steps, so as to produce output data representative of a time evolution of the molecular system relative to a time interval corresponding to the predetermined number of time steps.

3. A method according to claim 1, wherein the constraining equation includes |e|=1.

4. A method according to claim 1, wherein the set of equations for characterizing multibody dynamics includes equations of motion for each of a plurality of bodies in the system, the equations of motion given by
\dot{e}=W(ω)e
\dot{x}=C(e)u
\dot{ξ}=U_{ξ}
\dot{p}_{ω}=G_{ω}(q)+p^{T}[A_{ω}]p
\dot{p}ᵤ=Gᵤ(q)+p^{T}[Aᵤ]p
\dot{p}_{ξ}=G_{ξ}(q)+p^{T}[A_{ξ}]p
wherein the matrices W(ω) and C(e) represent the kinematical relations and are written in the form
$$W ( ω ) = \frac{1}{2} [ \begin{matrix}0 & - {ω}_{x} & - {ω}_{y} & - {ω}_{z} \\ {ω}_{x} & 0 & {ω}_{z} & - {ω}_{y} \\ {ω}_{y} & - {ω}_{z} & 0 & {ω}_{x} \\ {ω}_{z} & - {ω}_{y} & - {ω}_{x} & 0\end{matrix} ] and , \\ C ( e ) = [ \begin{matrix}1 - 2 ( {e}_{2}^{2} + {e}_{3}^{2} ) & 2 ( {e}_{1} {e}_{2} + {e}_{3} {e}_{0} ) & 2 ( {e}_{1} {e}_{3} - {e}_{2} {e}_{0} ) \\ 2 ( {e}_{2} {e}_{1} - {e}_{3} {e}_{0} ) & 1 - 2 ( {e}_{3}^{2} + {e}_{1}^{2} ) & 2 ( {e}_{2} {e}_{3} + {e}_{1} {e}_{0} ) \\ 2 ( {e}_{3} {e}_{1} + {e}_{2} {e}_{0} ) & 2 ( {e}_{3} {e}_{2} - {e}_{1} {e}_{0} ) & 1 - 2 ( {e}_{1}^{2} + {e}_{2}^{2} )\end{matrix} ] , respectively .$$

5. A method according to claim 1, wherein applying the integrator to the set of equations over a time step further includes propagating Euler parameters of the set of equations for characterizing multibody dynamics, according to the matrix exponential of ₑ _{_{½}}=E(_{ω}_{_{½}})ₑ_{₀}.

6. A method according to claim 1, wherein applying the integrator to the set of equations over a time step further includes:
propagating a momentum vector to a half step t=Δt/2, while freezing one or more position states at t=0;
propagating a vector of rigid position variables to the half step t=Δt/2, while freezing one or more flexible position variables at t=0, and the momentum vector at t=Δt/2;
propagating the vector of flexible position variables to the full step t=Δt using momenta, recomputed in modal velocities, at t=Δt/2:
propagating the vector of rigid position variables to the full step t=Δt, while freezing the flexible position variables at t=Δt and the momentum vector at t=Δt/2; and,
propagating the momentum vector to the fill step t=Δt freezing the position states at t=Δt.

7. A method according to claim 1, wherein applying the integrator to the set of equations over a time step further includes decomposing the set of equations for characterizing multibody dynamics first with respect to momentum states, and then with respect to position and rigid and flexible degrees of freedom.

8. A method according to claim 1, wherein applying the integrator to the set of equations over a time step further includes decomposing the set of equations for characterizing multibody dynamics first with respect to rigid and flexible degrees of freedom, and then with respect to position and momentum states.

9. A method according to claim 1, wherein providing an integrator includes solving a kinematic equation associated with the set of equations for characterizing multibody dynamics via a solution based on a matrix exponential of the form
$$E ( {ω}_{1 / 2} ) = {ⅇ}^{{w}_{( {ω}_{1 / 2} )} \frac{Δ t}{2}} = cos ( γΔ t ) I + sin ( γΔ t ) D .$$

10. A computer system for simulating multibody dynamics of a molecular system so as to produce output data representative of a time evolution of the molecular system, comprising:
an analytical structure for characterizing multibody dynamics of the molecular system, wherein the analytical structure is constrained by a constraining equation;
an integrator for integrating the analytical structure, wherein the integrator is tailored for the structure so as to satisfy the constraining equation;
wherein the integrator integrates the structure over a time step, so as to produce output data representative of a time evolution of the molecular system relative to the time step.

11. A computer system according to claim 10, wherein the analytical structure includes a set of equations modeled in a computer code.

12. A computer system according to claim 11, wherein the set of equations includes equations of motion for each of a plurality of bodies in the molecular system, the equations of motion given by
\dot{e}=W(ω)e
\dot{x}=C(e)u
\dot{ξ}=U_{ξ}
\dot{p}_{ω}=G_{ω}(q)+p^{T}[A_{ω}]p
\dot{p}ᵤ=Gᵤ(q)+p^{T}[Aᵤ]p
\dot{p}_{ξ}=G_{ξ}(q)+p^{T}[A_{ξ}]p
wherein the matrices W(ω) and C(e) represent the kinematical relations and are written in the form
$$W ( ω ) = \frac{1}{2} [ \begin{matrix}0 & - {ω}_{x} & - {ω}_{y} & - {ω}_{z} \\ {ω}_{x} & 0 & {ω}_{z} & - {ω}_{y} \\ {ω}_{y} & - {ω}_{z} & 0 & {ω}_{x} \\ {ω}_{z} & - {ω}_{y} & - {ω}_{x} & 0\end{matrix} ] and , \\ C ( e ) = [ \begin{matrix}1 - 2 ( {e}_{2}^{2} + {e}_{3}^{2} ) & 2 ( {e}_{1} {e}_{2} + {e}_{3} {e}_{0} ) & 2 ( {e}_{1} {e}_{3} - {e}_{2} {e}_{0} ) \\ 2 ( {e}_{2} {e}_{1} - {e}_{3} {e}_{0} ) & 1 - 2 ( {e}_{3}^{2} + {e}_{1}^{2} ) & 2 ( {e}_{2} {e}_{3} + {e}_{1} {e}_{0} ) \\ 2 ( {e}_{3} {e}_{1} + {e}_{2} {e}_{0} ) & 2 ( {e}_{3} {e}_{2} - {e}_{1} {e}_{0} ) & 1 - 2 ( {e}_{1}^{2} + {e}_{2}^{2} )\end{matrix} ] , respectively .$$

13. A computer system according to claim 10, wherein the constraining equation includes |e|=1.

14. A computer system according to claim 10, wherein the integrator further integrates the structure over a predetermined number of time step, so as to produce output data representative of a time evolution of the molecular system relative to a time interval corresponding to the predetermined number of time steps.

15. A computer system according to claim 10, wherein the integrator further propagates Euler parameters of the set of equations for characterizing multibody dynamics, according to the matrix exponential of e_{½}=E(ω_{½}) e₀.

16. A computer system according to claim 10, wherein the integrator further solves a kinematic equation associated with the set of equations for characterizing multibody dynamics via a solution based on a matrix exponential of the form
$$E ( {ω}_{1 / 2} ) = {ⅇ}^{{w}_{( {ω}_{1 / 2} )} \frac{Δ t}{2}} = cos ( γΔ t ) I + sin ( γΔ t ) D .$$

17. A computer system according to claim 10, wherein the integrator further decomposes the set of equations for characterizing multibody dynamics first with respect to momentum states, and then with respect to position and rigid and flexible degrees of freedom.

18. A computer system according to claim 10, wherein the integrator further decomposes the set of equations for characterizing multibody dynamics first with respect to rigid and flexible degrees of freedom, and then with respect to position and momentum states.

19. A computer system for simulating multibody dynamics of a molecular system so as to produce output data representative of a time evolution of the molecular system, comprising:
means for characterizing multibody dynamics of the molecular system, wherein the analytical structure is constrained by a constraining equation;
means for integrating the analytical structure, wherein the integrator is tailored for the structure so as to satisfy the constraining equation;
wherein the means for integrating integrates the structure over a time step, so as to produce output data representative of a time evolution of the molecular system relative to the time step.

20. A computer system according to claim 19, wherein the analytical structure includes equations of motion, modeled in computer code, for each of a plurality of bodies in the molecular system, the equations of motion given by
\dot{e}=W(ω)e
\dot{x}=C(e)u
\dot{ξ}=U_{ξ}
\dot{p}_{ω}=G_{ω}(q)+p^{T}[A_{ω}]p
\dot{p}ᵤ=Gᵤ(q)+p^{T}[Aᵤ]p
\dot{p}_{ξ}=G_{ξ}(q)+p^{T}[A_{ξ}]p
wherein the matrices W(ω) and C(e) represent the kinematical relations and are written in the form
$$W ( ω ) = \frac{1}{2} [ \begin{matrix}0 & - {ω}_{x} & - {ω}_{y} & - {ω}_{z} \\ {ω}_{x} & 0 & {ω}_{z} & - {ω}_{y} \\ {ω}_{y} & - {ω}_{z} & 0 & {ω}_{x} \\ {ω}_{z} & - {ω}_{y} & - {ω}_{x} & 0\end{matrix} ] and , \\ C ( e ) = [ \begin{matrix}1 - 2 ( {e}_{2}^{2} + {e}_{3}^{2} ) & 2 ( {e}_{1} {e}_{2} + {e}_{3} {e}_{0} ) & 2 ( {e}_{1} {e}_{3} - {e}_{2} {e}_{0} ) \\ 2 ( {e}_{2} {e}_{1} - {e}_{3} {e}_{0} ) & 1 - 2 ( {e}_{3}^{2} + {e}_{1}^{2} ) & 2 ( {e}_{2} {e}_{3} + {e}_{1} {e}_{0} ) \\ 2 ( {e}_{3} {e}_{1} + {e}_{2} {e}_{0} ) & 2 ( {e}_{3} {e}_{2} - {e}_{1} {e}_{0} ) & 1 - 2 ( {e}_{1}^{2} + {e}_{2}^{2} )\end{matrix} ] , respectively .$$
